(19) United States
(12) Patent Application Publication
(10) Pub. No.: US 2016/0019482 A1
(43) Pub. Date: Jan. 21, 2016

(54) METHOD AND SYSTEM FOR MONITORING A PRODUCTION FACILITY FOR A RENEWABLE FUEL

(71) Applicant: Genscape Intangible Holding, Inc., Louisville, KY (US)

(72) Inventors: George J. Venhoff, Louisville, KY (US); Creed Taylor Morgan Gann, Lexington, KY (US); Susan Olson, Louisville, KY (US); Deirdre Alphenaar, Prospect, KY (US)

(21) Appl. No.: 14/800,143

(22) Filed: Jul. 15, 2015

Related U.S. Application Data
(60) Provisional application No. 62/024,852, filed on Jul. 15, 2014.

(51) Int. Cl. G06Q 10/06; G06F 17/50

(52) U.S. Cl. CPC G06Q 10/0639; G06F 17/5009

(57) ABSTRACT

A method for monitoring a production facility for a renewable fuel comprises the steps of: identifying certain operating parameters for the production facility; establishing a transform which models the production facility or a functional subsection thereof as a function of at least one operating condition, wherein the transform is based, in part, on the certain operating parameters; monitoring the at least one operating condition of the production facility by collecting data from a sensor; applying the transform to the data collected from the sensor to determine a status of the production facility; and communicating the status of the production facility to an interested party. The method may further comprise the step of determining whether the production rate over an defined time period is consistent with the registration of Renewable Identification Numbers (RINs) for the defined time period.

### CROSS-REFERENCE TO RELATED APPLICATIONS

The present application claims priority to U.S. patent application Ser. No. 62/024,852 filed on Jul. 15, 2014.

### BACKGROUND OF THE INVENTION

Renewable fuels reduce carbon emissions from vehicles. In an effort to provide a structured market and market-based incentives to track the production of renewable fuels (for example, biodiesel), the United States Environmental Protection Agency (EPA) developed a system of assigning carbon reduction credits to each physical gallon (or gallon equivalent) of renewable fuel produced. The credits originate with the production of the renewable fuel, but once registered through an EPA central registration process, these credits become independently tradeable entities called Renewable Identification Numbers (or RINs). For instance, once produced, one ethanol-equivalent gallon of renewable fuel can be associated with one equivalent Renewable Identification Number (RIN).

A renewable fuel producer must correctly register and initiate the existence of a RIN for each ethanol-equivalent gallon of renewable fuel produced at its production facility. A gallon of renewable fuel can be sold through any number of intermediate market participants before finally being blended with a transport fuel, such as gasoline. In most cases, blending takes place at a refinery or gasoline storage facility. Once used in neat form or in the blending process, each RIN associated with the blended gallon must eventually be retired from the RIN management system, or the RIN credit will expire. In theory, the number of gallons produced should match (or be directly proportional to) the number of RINs in circulation, and the number of ethanol-equivalent gallons of renewable fuel blended should match the number of RINs being retired from the RIN management system on a continual basis.

Unfortunately, however, there have been various instances of fraud associated with such a RIN management system. Thus, it has often been necessary to have third-party auditing or verification of RINs registered and put into market circulation by the producer of a renewable fuel to ensure that there is a true and accurate match with the number of ethanol-equivalent gallons of renewable fuel produced.

### SUMMARY OF THE INVENTION

The present invention is a method and system for monitoring a production facility for a renewable fuel using operator-independent means to generate operational and production data for the monitored production facility. Such data is then used, for example, to ensure that there is a true and accurate reporting of the number of gallons of renewable fuel produced and the number of registered RINs.

A production facility for a renewable fuel can be broken down and classified into subsections (or areas) based on function. In general, these functions would typically include: (1) intake and storage of feedstock and processing materials; (2) transfer and storage of feedstock and processing material into preprocessing; (3) transfer of feedstock and processing materials into processing tanks; (4) transfer of intermediate products between processing tanks; (5) transfer and storage of end-products and waste by-products of production; and (6) transportation of end-products and waste by-products away from the production facility.

Of course, for a particular production facility, certain operating parameters are known and constant over long periods of time, for example: the number of storage tanks; tank content type; maximum tank volumes; tank heights; number of facility pipelines; pipeline input and output connections; pipeline diameter; number of pumps; pump types; pump function; import loading locations; and export loading locations. Thus, such operating parameters can be identified as part of an initial inspection and profiling of a production facility and stored in a database at a central processing facility.

In order to effectively monitor the production facility, certain operating conditions associated with one or more of the above-described functions must also be monitored. Accordingly, one or more appropriate sensors are chosen for monitoring a selected parameter of a functional subsection, and an appropriate location for each such sensor is then identified. Each sensor may be characterized as a “node” in a network of sensors that monitor the production facility or a functional subsection thereof, and the data from each node is collected at regular intervals and transferred to a central processing facility for storage in a database at the central processing facility.

At the central processing facility, the collected and stored data is then analyzed using a computer program, i.e., computer-readable instructions stored in a memory component and executed by a processor of a computer system. Such analysis of the collected and stored data thus allows for effective monitoring of the functions of the production facility and the development of an automated mass-balance calculator for the production facility.

Data from a sensor may be representative of volume of material present or a flow rate of material entering or leaving with respect to a particular node.

With respect to the measurement of flow rates of materials entering or leaving with respect to a particular node, in some exemplary implementations, to collect flow rate data, current sensors are placed on power cables associated with the pumps in one or more of the functional subsections of the production facility. Each such sensor will monitor and measure the current draw of a particular pump.

With respect to the measurement of flow rates of materials entering or leaving with respect to a particular node, in some exemplary implementations, it might be desirable to install sensors to determine the flow of materials in pipes connecting one or more of the functional subsections of the production facility. For instance, such measurements may be achieved through the installation of flowmeters which provide an output signal representative of the flow rate and cumulative volume of material that has moved through a pipe.

With respect to the measurement of volumes of feedstock, processing materials, and/or product at a production facility or in a particular functional subsection, in some exemplary implementations, sensors are installed to monitor selected tanks and determine the level of material in such tanks, which then allows for a calculation of volume in such tanks.

After collecting and storing data, whether from current sensors, flowmeters, level sensors, or other types of sensors, the data can be analyzed using signal processing techniques and/or charted against the production rates for the production facility and/or against other sources of data provided by the production facility.

Each such data set, alone or in combination with other data sets, can then be compared with historic production data and other operational data from the production facility, including, for example, on times, off times, periods of malfunction or maintenance, and periods at maximum or minimum production rates.

From such comparisons and analysis, a series of transforms are then established which take collected data and transform the collected data into production information, including, for example, production rates, storage volumes, processing rates, product export rates, and feedstock import rates. Similarly, a series of transforms can also be established which take collected data and transform the collected data into operational statuses for the production facility, including, for example, normal operation of the facility, abnormal operation of the facility, facility shut-down, facility start-up, malfunction, and facility at maximum or minimum operating rates.

Once such transforms have been established, they are stored in a database at the central processing facility. As data is subsequently received from one or more sensors, each transform can be applied to the data collected from the one or more sensors. The result of each such application of a transform is a status of the production facility, whether expressed as a production rate or other quantity, or expressed as an operational status (for example, normal or abnormal operations). That result is then communicated to interested parties, including third parties who would otherwise not have access to such status information (because it is ordinarily controlled by operators).

Furthermore, by monitoring operation of a production facility for a renewable fuel in this manner, it is possible to ensure that there is a true and accurate reporting of the number of gallons of renewable fuel produced and the number of registered RINs. Specifically, by monitoring certain operating conditions of the production facility and determining the status of the production facility or identifying any abnormal operations, it can be readily confirmed that the production facility did indeed produce the number of gallons of renewable fuel that have been reported and associated with registered RINs.

### DESCRIPTION OF THE DRAWINGS

FIG. 1 is a schematic view of the functional subsections of a biodiesel production facility;

FIG. 2 is a chart illustrating a tank level signal for a storage tank of a biodiesel production facility;

FIG. 3 is a chart illustrating both the flow signal and cumulative volume signal from a flowmeter monitoring the movement of finished biodiesel in a biodiesel production facility;

FIG. 4 is a chart illustrating the current output signal collected from a sensor monitoring a pump of a biodiesel production facility;

FIG. 5 is a chart illustrating production data as compared to a current output signal collected from two load-out pumps over a time period;

FIG. 6 is a chart illustrating a sample modeling between daily product generated at a biodiesel production facility against a combined measured current from two sensors measuring current draw on two load-out pumps of the biodiesel production facility;

FIG. 7 is a schematic view illustrating a typical mass-balance profile for a biodiesel production facility;

FIG. 8 is a chart that plots the measured current from the sensors for two pumps of a biodiesel production facility;

FIG. 9 is a chart that illustrates the use of a cross-correlation function;

FIG. 10 is a chart that plots the measured volume change over time from tank level sensors for two tanks of a biodiesel production facility;

FIG. 11 is a chart that plots the measured flow rate through two pipes of a biodiesel production facility using flowmeter sensors;

FIG. 12 is a chart of two signals from a single sensor associated with a load-out pump of a biodiesel production facility;

FIG. 13 is a chart of total pump usage of a biodiesel production facility over several daily periods;

FIG. 14 is a chart of two signals from a single sensor associated with a final storage tank of a biodiesel production facility;

FIG. 15 is a chart of total tank level injections and withdrawals of a biodiesel production facility over several daily periods;

FIG. 16 is a chart of three signals from a single flowmeter associated with flow through a load-out pipe of a biodiesel production facility;

FIG. 17 is a chart of total material flow of a biodiesel production facility over several daily periods; and

FIG. 18 is a schematic and flow chart depicting the general functionality of an exemplary implementation of the method and system of the present invention.

### DETAILED DESCRIPTION OF THE INVENTION

The present invention is a method and system for monitoring a production facility for a renewable fuel using operator-independent means to generate operational and production data for the monitored production facility. Such data is then used, for example, to ensure that there is a true and accurate reporting of the number of gallons of renewable fuel produced and the number of registered RINs.

A production facility for a renewable fuel can be broken down and classified into subsections (or areas) based on function. In general, these functions would typically include: (1) intake and storage of feedstock and processing materials; (2) transfer and storage of feedstock and processing material into preprocessing; (3) transfer of feedstock and processing materials into processing tanks; (4) transfer of intermediate products between processing tanks; (5) transfer and storage of end-products and waste by-products of production; and (6) transportation of end-products and waste by-products away from the production facility.

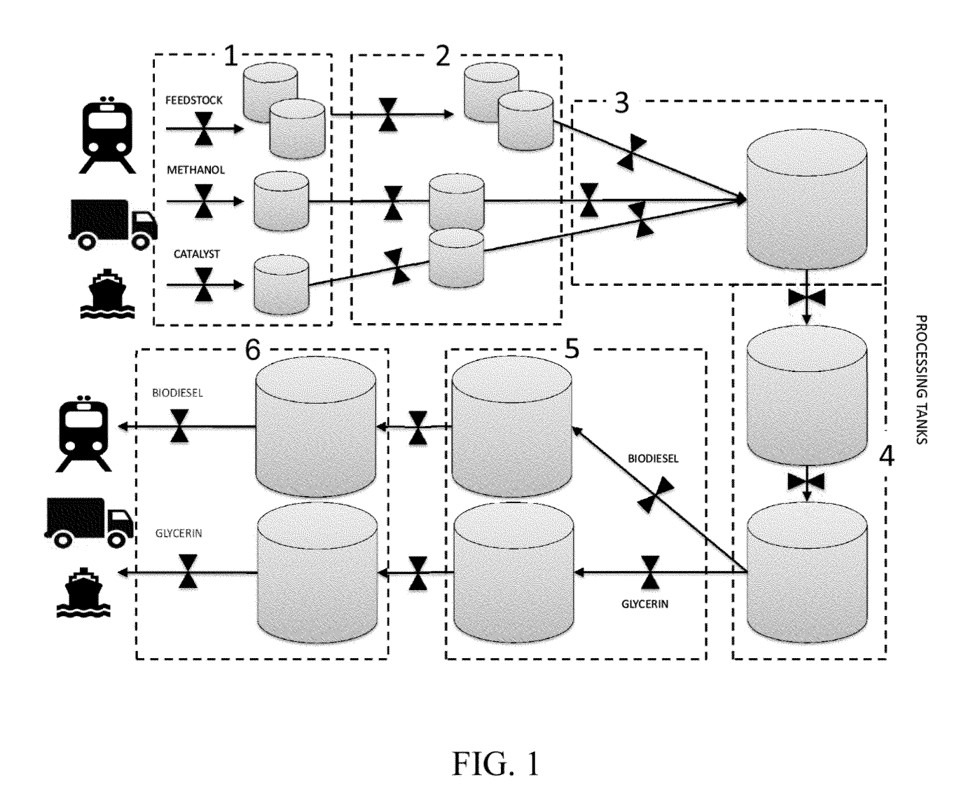

For example, and referring now to FIG. 1, for a biodiesel production facility, the functions would typically include: (1) intake and storage of feedstock, methanol, catalyst, and any other needed processing materials; (2) transfer and storage of feedstock, methanol, catalyst, and any other processing materials into preprocessing; (3) transfer of feedstock, methanol, catalyst, and any other processing materials into processing tanks; (4) transfer of product between processing tanks, including transesterification, esterification, cooling, polishing, etc.; (5) transfer and storage of end-products, such as glycerin and finished biodiesel, to final storage tanks; and (6) transportation of end-products, such as glycerin and finished biodiesel, from the production facility.

Again, although the above example and FIG. 1 illustrate a biodiesel production facility, production facilities for other renewable fuels, including those recognized by the Renewable Fuel Standard 40 C.F.R §80, Subtitle M, such as non-cellulosic ethanol, cellulosic ethanol, renewable diesel oil, renewable heating oil, and renewable compressed natural gas, can be similarly broken down and classified into functional subsections (or areas).

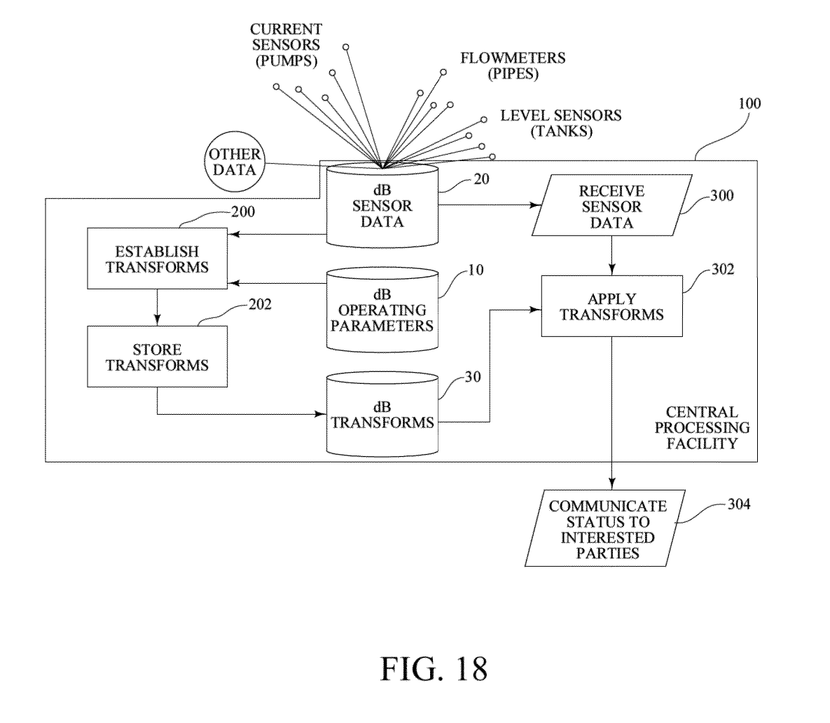

Of course, for a particular production facility, certain operating parameters are known and constant over long periods of time, for example: the number of storage tanks; tank content type; maximum tank volumes; tank heights; number of facility pipelines; pipeline input and output connections; pipeline diameter; number of pumps; pump types; pump function; import loading locations; and export loading locations. Thus, such operating parameters can be identified as part of an initial inspection and profiling of a production facility and stored in a database 10 at a central processing facility 100 (i.e., stored in a memory component of a computer system), as shown in the schematic and flow chart of FIG. 18.

In order to effectively monitor the production facility, certain operating conditions associated with one or more of the above-described functions must also be monitored. Accordingly, one or more appropriate sensors is chosen for monitoring a selected parameter of a functional subsection, and an appropriate location for each such sensor is then identified. Each sensor may be characterized as a “node” in a network of sensors that monitor the production facility or a functional subsection thereof, and the data from each node is collected at regular intervals and transferred to a central processing facility for storage in a database 20 at the central processing facility 100 (i.e., stored in a memory component of a computer system), as shown in the schematic and flow chart of FIG. 18. For instance, data from a sensor may be representative of volume of material present or a flow rate of material entering or leaving with respect to a particular node, as further described below.

At the central processing facility 100, the collected and stored data is then analyzed using a computer program, i.e., computer-readable instructions stored in a memory component and executed by a processor of a computer system. Thus, execution of the requisite routines and subroutines can be carried out using standard programming techniques and languages. With benefit of the following description, such programming is readily accomplished by one of ordinary skill in the art.

For instance, and as further described below, production at the facility may be modeled from data about: (i) the import of feedstock and processing materials (i.e., “raw materials”) into the production facility or a functional subsection thereof as a function of time; (ii) the raw materials into and out of functional subsections of the production facility as a function of time; and/or (iii) the amount of materials being stored at any time at the production facility or in a functional subsection thereof. Such materials in storage include not only feedstock (e.g., used cooking oil or soybean oil) and processing materials (e.g., methanol and/or catalyst), but also intermediate materials produced during the production cycle (e.g., glycerin), waste materials, and/or finished end-products (e.g., biodiesel). In any event, and as further described below, such analysis of the collected and stored data thus allows for effective monitoring of the functions of the production facility and the development of an automated mass balance calculator for the production facility.

As mentioned above, data from a sensor may be representative of volume of material present or a flow rate of material entering or leaving with respect to a particular node. With respect to the measurement of flow rates of materials entering or leaving with respect to a particular node, in some exemplary implementations, to collect flow rate data, current sensors are placed on power cables associated with the pumps in one or more of the functional subsections of the production facility. In this regard, it is preferred that such placement is non-invasive (e.g., around the power cables) and does not interrupt operation. For example, one preferred sensor for use in the method and system of the present invention is a P3E™ sensor manufactured and distributed by Panoramic Power Ltd. of Kfar Saba, Israel. In other words, sensors are effectively placed “around” a production facility to monitor the production facility, but are not necessarily “in-line” with operations of the production facility. Each such sensor will monitor and measure the current draw of a particular pump. In the case of a biodiesel production facility, pumps of interest may include, but are not limited to: pumps associated with intake of feedstock, methanol, catalyst, and any other needed processing materials in functional subsection 1 (FIG. 1); pumps associated with transfer of glycerin and finished biodiesel to final storage tanks in functional subsection 5 (FIG. 1); and/or pumps associated with the transportation of end-products, such as glycerin and finished biodiesel, from the production facility in functional subsection 6 (FIG. 1).

Referring again to FIG. 18, as stated above, each current sensor that is placed on a power cable may be characterized as a “node” in the network of sensors, and the data from each node is collected at regular intervals and transferred to the central processing facility 100 for storage in a database 20.

With respect to the measurement of flow rates of materials entering or leaving with respect to a particular node, in some exemplary implementations, it might be desirable to install sensors to determine the flow of materials in pipes connecting one or more of the functional subsections of the production facility. For instance, such measurements may be achieved through the installation of flowmeters, which use a variety of sensing methods to detect material flow, including, but not limited, to, Coriolis mass flow detection, ultrasonic pulses, and mechanical methods, such as a paddlewheel.

For example, a suitable Coriolis mass flowmeter for use with the present invention is the Optimass 1000 manufactured and distributed by KROHNE Messtechnik GmbH of Duisburg, Germany. Such a Coriolis mass flowmeter is installed in-line in a selected pipe and measures the Coriolis force generated by the fluid traveling through tubes within the flowmeter, which can then be used to calculate flow rate and total volume of material that has moved through the pipe.

For another example, a suitable ultrasonic flowmeter for use with the present invention is the EF10 Wall-Mount Ultrasonic Flowmeter manufactured and distributed by Spire Metering Technology of Acton, Massachusetts. Such an ultrasonic flowmeter can be installed in-line in a selected pipe or placed around a selected pipe. Using a transmitter and receiver, the ultrasonic flowmeter sends ultrasonic pulses through the material being conveyed through the pipe. Based on the transit times of the ultrasonic pulses, a flow rate can be calculated, along with a total volume of material that has moved through the pipe.

For another example, a suitable paddlewheel-type flowmeter for use with the present invention is the Signet 2537 Paddlewheel Flowmeter manufactured and distributed by Georg Fischer Signet LLC of El Monte, Calif. Such a paddlewheel-type flowmeter is installed in-line in a selected pipe and calculates flow rate (and total volume of material that has moved through the pipe) by counting the number of rotations of the paddlewheel.

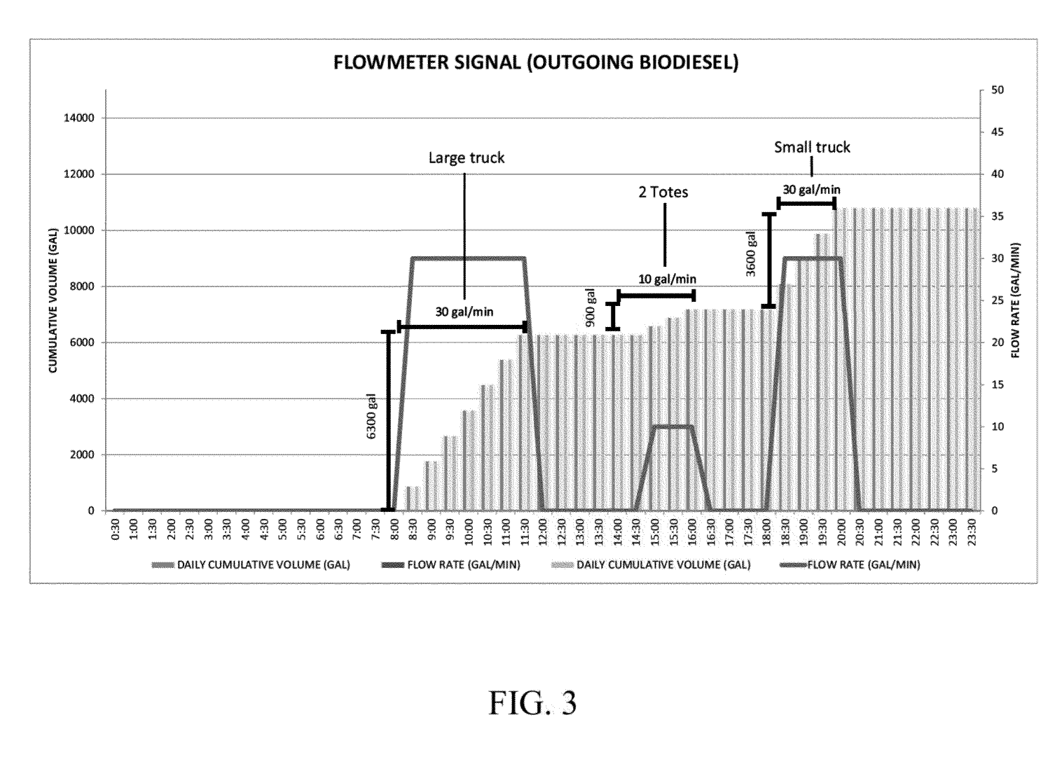

Regardless of which sensor is used, all such sensors provide an output signal representative of the flow rate and cumulative volume of material that has moved through a pipe. The flow rate and cumulative volume can be viewed as a signal over time for a particular pipe as illustrated in FIG. 3. In the case of a biodiesel production facility, pipes of interest may include, but are not limited to: pipes associated with intake of feedstock, methanol, catalyst, and any other needed processing materials in functional subsection 1 (FIG. 1); pipes associated with transfer of glycerin and finished biodiesel to final storage tanks in functional subsection 5 (FIG. 1); and/or pipes associated with the transportation of end-products, such as glycerin and finished biodiesel, from the production facility in functional subsection 6 (FIG. 1). In FIG. 3, the data is acquired from a flowmeter installed in a pipe that delivers finished biodiesel to a truck or other transport means, which is discussed in further detail below with respect to Example Transform 3.

Referring again to FIG. 18, similar to the current sensors described above, each flowmeter that is installed may be characterized as a “node” in the network of sensors, and the data from each node is collected at regular intervals and transferred to the central processing facility 100 for storage in a database 20.

With respect to the measurement of volumes of feedstock, processing materials, and/or product at a production facility or in a particular functional subsection, in some exemplary implementations, sensors are installed to monitor selected tanks and determine the level of material in such tanks, which then allows for a calculation of volume in such tanks For example, known level sensors include, but are not limited to, differential pressure gauges submerged in a tank, ultrasonic pulse sensors, radar-based sensors, floating devices, and/or switch devices.

For example, a suitable differential pressure gauge for use with the present invention is a combination of the PTX1240 Submersible Pressure Transmitter and Model 9175 wireless tank monitor, both manufactured and distributed by Electronic Sensors, Inc. of Wichita, Kans. In this case, the pressure transmitter is submerged into the material in a selected storage tank and detects the pressure from the volume of material that is above the pressure transmitter. Data from the pressure transmitter is then sent to the tank monitor, which collects the data and calculates the volume.

For another example, a suitable sensor that uses ultrasonic pulses for use with the present invention is an EchoSafe XP88 ultrasonic level transmitter manufactured and distributed by Flowline Inc. of Los Alamitos, Calif. The ultrasonic level transmitter is placed on top of a tank and sends an ultrasonic pulse downward into the tank. The ultrasonic pulse contacts the material stored in the tank and is then reflected back to the transmitter. The tank level (and tank volume) is determined by the amount of time it takes for the pulse to complete its travel.

For another example, a suitable sensor that uses radar signals for use with the present invention is the EchoPulse LR15 pulse radar level transmitter manufactured and distributed by Flowline Inc. of Los Alamitos, Calif. Similar to an ultrasonic level transmitter, the pulse radar level transmitter is placed on top of a tank and sends a radar pulse downward into the tank. The radar pulse contacts the material stored in the tank and is then reflected back to the transmitter. The tank level (and tank volume) is determined by the amount of time it takes for the pulse to complete its travel.

For another example, a suitable sensor that uses mechanical measurements for use with the present invention is the Centeron Float Monitor manufactured and distributed by Robertshaw Industrial Products of Maryville, Tenn. Such a float monitor makes use of a physical probe that is either submerged in or floats on top of the material stored in the tank. Using data collected from the probe, the tank level (and tank volume) is calculated.

For another example, a suitable sensor that uses temperature measurement for use with the present invention is the StorMax Retractable Temperature Cable manufactured and distributed by OPlsystems Inc. of Calgary, Alberta, Canada. A probe at a distal end of the cable is submerged into the material in a selected storage tank. The probe includes multiple thermocouples along its length. Based on the temperature differential at each thermocouple, the tank level (and tank volume) is calculated.

For another example, infrared sensing techniques, such as those described in U.S. Pat. No. 8,717,434, which is entitled “Method and System for Collecting and Analyzing Operational Information from a Network of Components Associated with a Liquid Energy Commodity” and is incorporated herein by reference, may be employed to determine levels within tanks of interest.

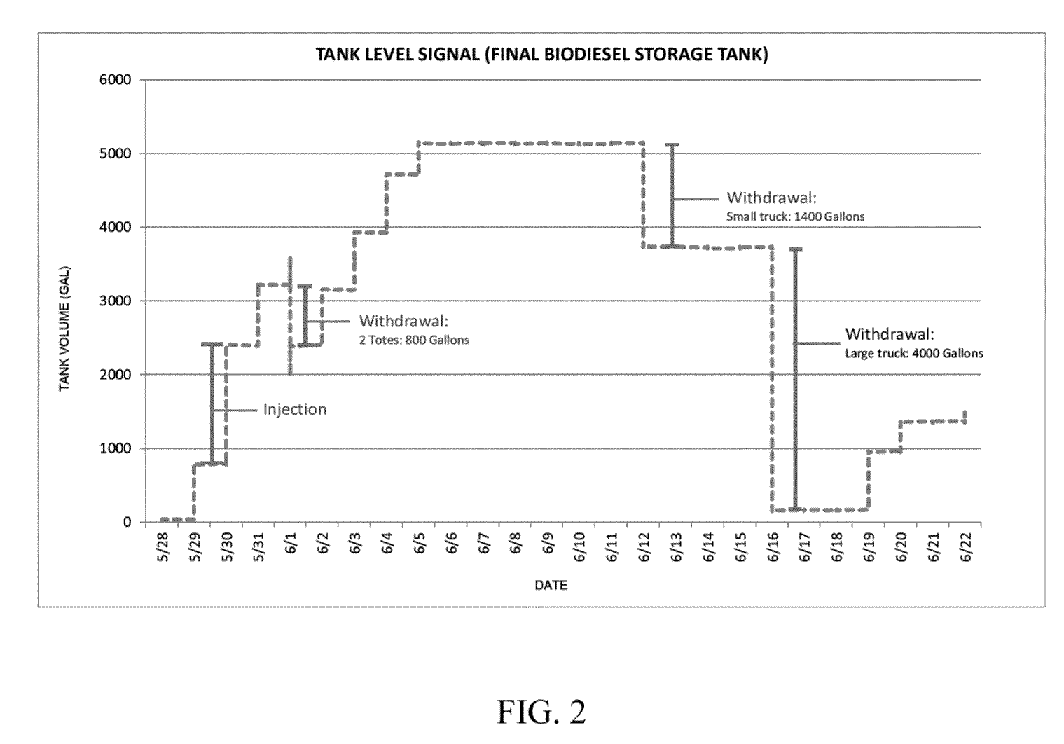

All such sensors provide a level of a storage tank at a production facility and, in turn, provide the current volume of the storage tank. The level reported by a tank level meter over time can be represented as a signal for a particular tank as illustrated in FIG. 2, which is discussed in further detail below with respect to Example Transform 2.

Referring again to FIG. 18, similar to the sensors described above, each sensor that is installed may be characterized as a “node” in the network of sensors, and the data from each node is collected at regular intervals and transferred to the central processing facility 100 for storage in a database 20.

After collecting and storing data, whether from current sensors, flowmeters, level sensors, or other types of sensors, the data can be analyzed using signal processing techniques and/or charted against the production rates for the production facility and/or against other sources of data provided by the production facility. Examples of sensor-derived data sets include:

1. sensor signal amplitudes defined by minimum, maximum, and average;

2. sensor signal frequency defined by repetitive signal occurrence (cycles per time period) and periodicity (time delays between repeating signal patterns);

3. rate of change in signal on/off rates and transitions from one signal amplitude to another (i.e., pattern sets);

4. relative signal-to-noise ratios; and

5. relative timing of signals from different pumps (or nodes) derived from signal cross-correlation analysis.

Each such data set, alone or in combination with other data sets, can then be compared with historic production data and other operational data from the production facility, including, for example, on times, off times, periods of malfunction or maintenance, and periods at maximum or minimum production rates. With respect to operational data from the production facility, one contemplated way to collect such data is the use of a PLC-interface device which directly connects to the internal operational SCADA system at the production facility, for example, by setting up a data feed that routes the data from the SCADA system offsite for subsequent review and analysis.

For example, commonly owned U.S. Pat. No. 8,972,273 is entitled “Method and System for Providing Information to Market Participants about One or More Power Generating Units Based on Thermal Image Data.” U.S. Pat. No. 8,972,273, which is incorporated herein by reference, describes a method and system that allows for an accurate assessment of the operational status of a particular power plant (or similar facility), including an identification of which power generating units are on and which are off. An exemplary system in includes, inter alia: (i) a monitor component for acquiring thermal data from a smokestack and/or the gas plume emitted from the smokestack of a power plant (or similar facility); (ii) a video capture component for recording images of the acquired thermal data; (iii) a data transmission component for transmitting the recorded images to a central processing facility; and (iv) an analysis component for analyzing the recorded images and, using one or more databases storing information regarding the nature and capability of that power plant (or similar facility), drawing an inference as to the operational status of that power plant (or similar facility). The resultant data may be accessed and used in the method and system of the present invention.

For another example, commonly owned U.S. Pat. No. 8,842,874 is entitled “Method and System for Determining an Amount of a Liquid Energy Commodity Stored in a Particular Location.” U.S. Pat. No. 8,842,874 , which is incorporated herein by reference, notes that many liquid energy commodities are stored in large, above-ground tanks that either have: a floating roof, which is known as an External Floating Roof (EFR); or a fixed roof with a floating roof internal to the tank, which is known as an Internal Floating Roof (IFR). U.S. Pat. No. 8,842,874 thus describes and claims a method for determining an amount of a liquid energy commodity stored in a particular location, including, inter alia: (i) storing volume capacity information associated with each tank at the particular location in a database; (ii) periodically conducting an inspection of each tank at the particular location from a remote vantage point and without direct access to each tank, including collecting one or more images of each tank; (iii) transmitting the collected images of each tank to a central processing facility; (iv) analyzing the collected images of each tank to determine a liquid level for each tank; and (v) calculating the amount of the liquid energy commodity in each tank based on the determined liquid level and the volume capacity information retrieved from the database. The resultant data may also be accessed and used in the method and system of the present invention.

For another example, commonly owned U.S. Pat. No. 8,717,434 is entitled “Method and System for Collecting and Analyzing Operational Information from a Network of Components Associated with a Liquid Energy Commodity.” U.S. Pat. No. 8,717,434, which is incorporated herein by reference, thus describes and claims a method that includes, inter alia: (i) measuring an amount of a liquid energy commodity in storage at one or more storage facilities in the network, and storing that measurement data in a first database at a central data processing facility; (ii) determining a flow rate of the liquid energy commodity in one or more selected pipelines in the network, and storing that flow rate data in a second database at the central data processing facility; (ii) ascertaining an operational status of one or more processing facilities in the network, and storing that operational status information in a third database at the central data processing facility; and (iv) analyzing the measurement data, the flow rate data, and the operational status information to determine a balance of the liquid energy commodity in the network or a selected portion thereof at a given time. The resultant data may also be accessed and used in the method and system of the present invention.

Referring again to FIG. 18, and as indicated by block 200, a series of transforms are then established which take collected data and transform the collected data into production information, including, for example, production rates, storage volumes, processing rates, product export rates, and feedstock import rates.

Similarly, as also indicated by block 200, a series of transforms are also established which take collected data and transform the collected data into operational statuses for the production facility, including, for example, normal operation of the facility, abnormal operation of the facility, facility shut-down, facility start-up, malfunction, and facility at maximum or minimum operating rates.

Once such transforms have been established, they are stored in a database 30 at the central processing facility 100 (i.e., stored in a memory component of a computer system), as indicated by block 202 in the schematic and flow chart of FIG. 18. As data is subsequently received from one or more sensors, as indicated by block 300 of FIG. 18, each transform can be applied to the data collected from the one or more sensors, as indicated by block 302 of FIG. 18. Such application of the transforms can be done in real-time or at scheduled intervals to analyze data over defined time periods. In any event, the result of each such application of a transform is a status of the production facility, whether expressed as a production rate or other quantity, or expressed as an operational status (for example, normal or abnormal operations). That result is then communicated to interested parties, as indicated by output 304 of FIG. 18, including third parties who would otherwise not have access to such status information (because it is ordinarily controlled by operators). It is contemplated and preferred that such communication to interested parties could be achieved through electronic mail delivery and/or through export of the data to an access-controlled Internet web site, which interested parties can access through a common Internet browser program. Of course, communication of information and data to interested parties could also be accomplished through a wide variety of other known communications media without departing from the spirit and scope of the present invention.

### EXAMPLE TRANSFORM 1

### Transforming a Pump Sensor Current Signal to a Production Flow Rate and Mass Balance

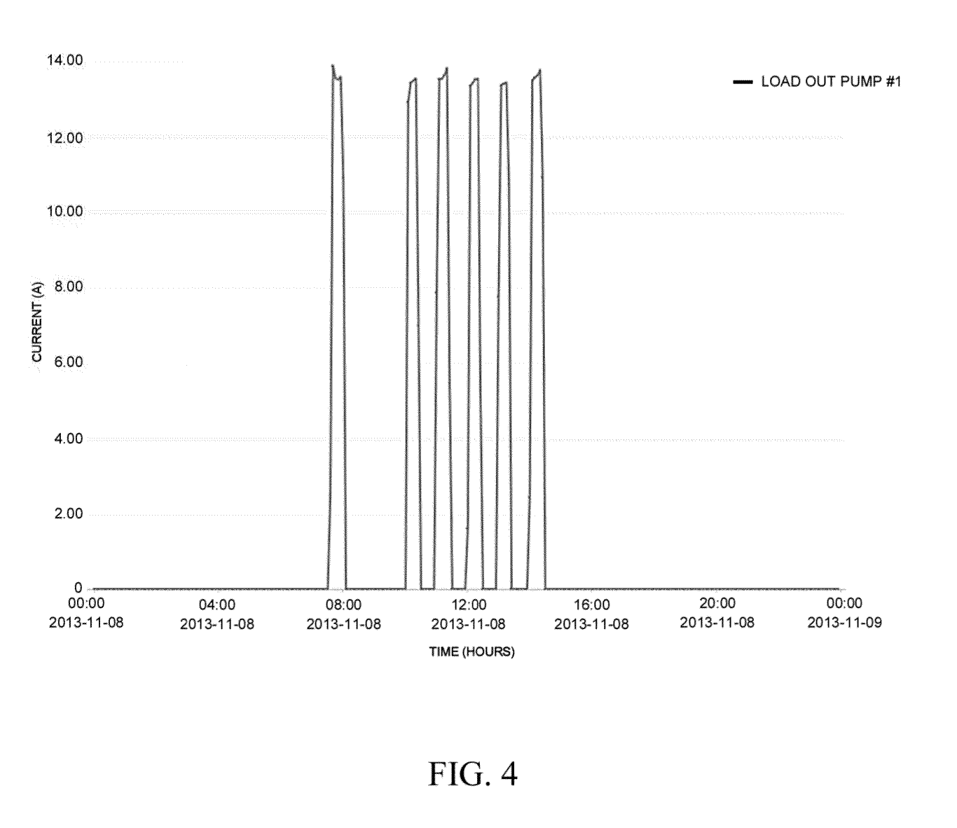

For a sensor placed on a power cable associated with a particular pump to monitor and measure the current draw of the pump, the sensor outputs a current output signal, Iₚᵢ. FIG. 4 is a chart illustrating the current output signal, Iₚᵢ, collected from the sensor monitoring the pump over a 24-hour time period.

By accessing and using other available information from the production facility (whether from public databases, prior collected data, information acquired from the production facility, or otherwise), such as production data, flow meter data, or tank level data, a transform is then established to correlate the flow rate of material through the pump, Qₚᵢ, to the current output signal, Iₚᵢ.

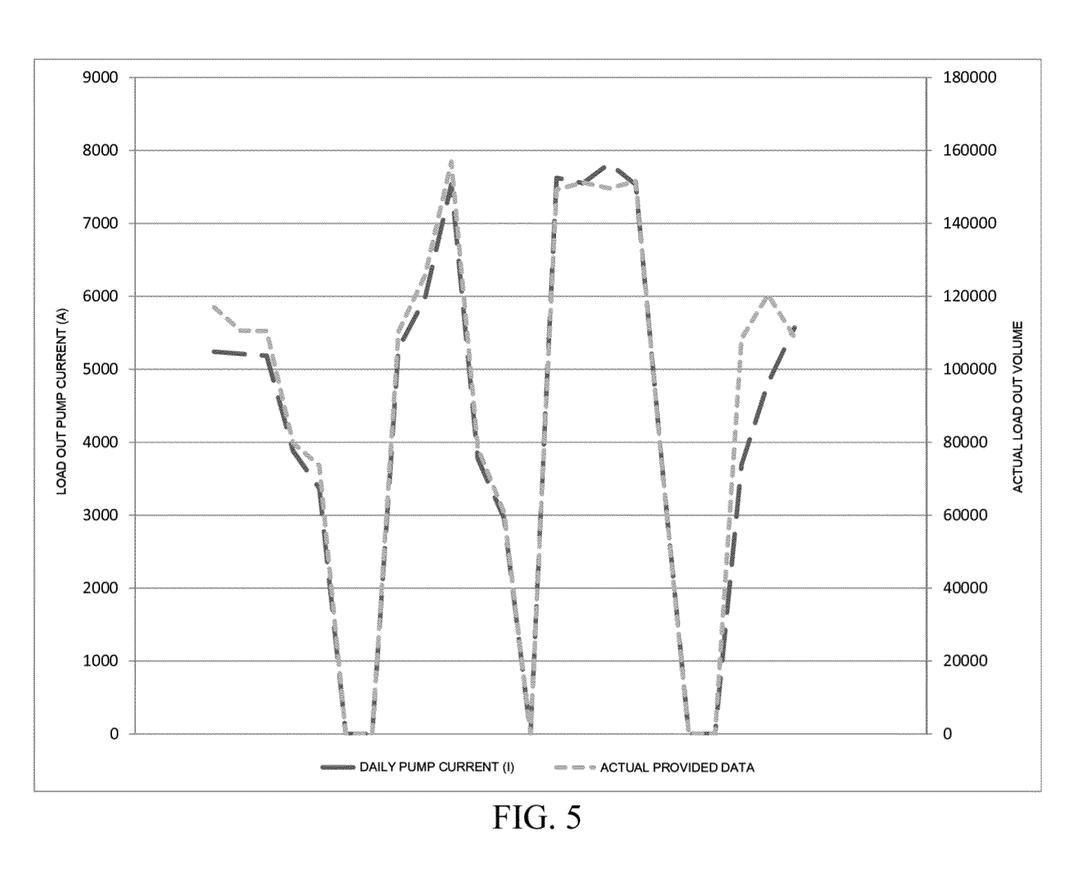

FIG. 5 is a chart that illustrates production data (actual load-out flow rate data) as compared to a current output signal, Iₚᵢ, collected from two load-out pumps (i.e., total amperage from the two load-out pumps) over a time period (daily). “Load-out” refers to the movement of a finished product, such as biodiesel or another renewable fuel, out of a production facility, i.e., in functional subsection 6 of FIG. 1.

Then, flow can be modeled with a linear regression:

Qₚᵢ=m*Iₚᵢ+b (1)

where m is the slope, and b is the y-intercept of the linear regression. Variables m and b will vary based on factors, including the type of pump(s), power of the pump(s), and the fluid properties of the material being transferred through the pump(s).

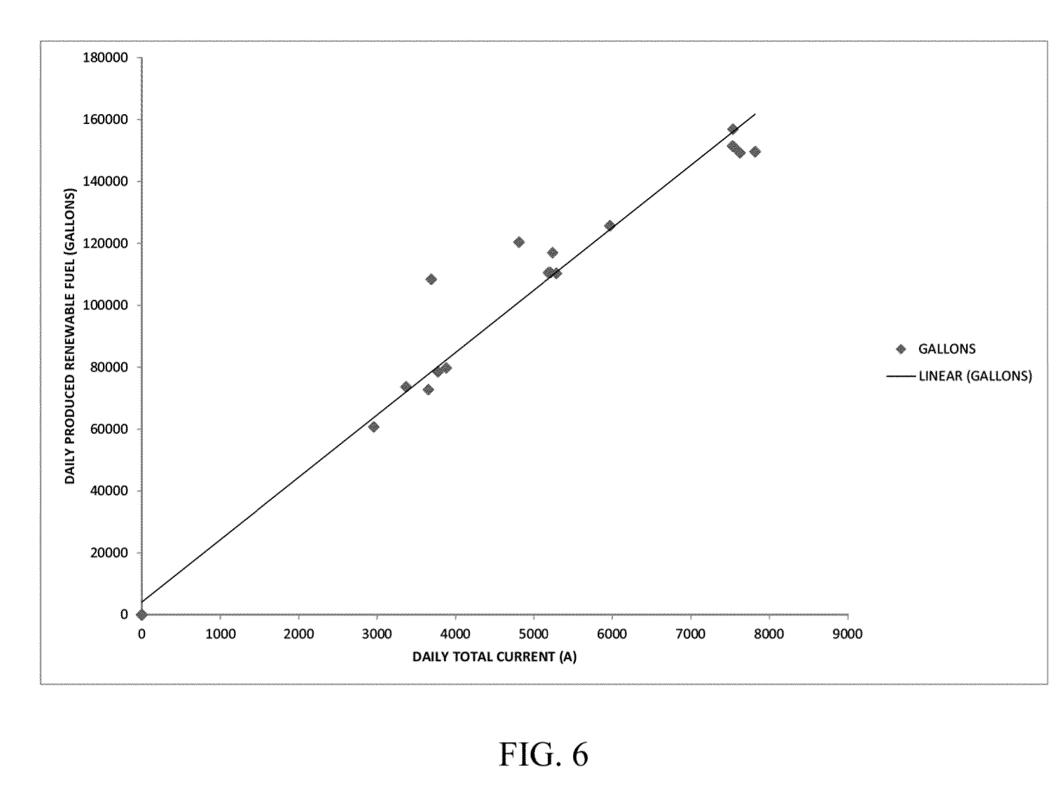

FIG. 6 is a chart illustrating the modeling of a sensor for the two load-out pumps using a simple linear regression; specifically, FIG. 6 illustrates a sample modeling between daily product generated at a production facility against a combined measured current from two sensors measuring current draw on two load-out pumps.

Once one or more pumps related to a production facility have been identified, sensors have been placed to collect data from such pumps, and a transform (or model) has been established for each pump, the overall flow of materials through the production facility can be monitored. Specifically, when the flow rate of material, Qᵢ, through each pump at a given time has been calculated, the volume of material flowing into and out of each functional subsection, Vᵢ, can be estimated:

ΔVᵢ=Qᵢ*Δt (2)

where Δt is the change in time.

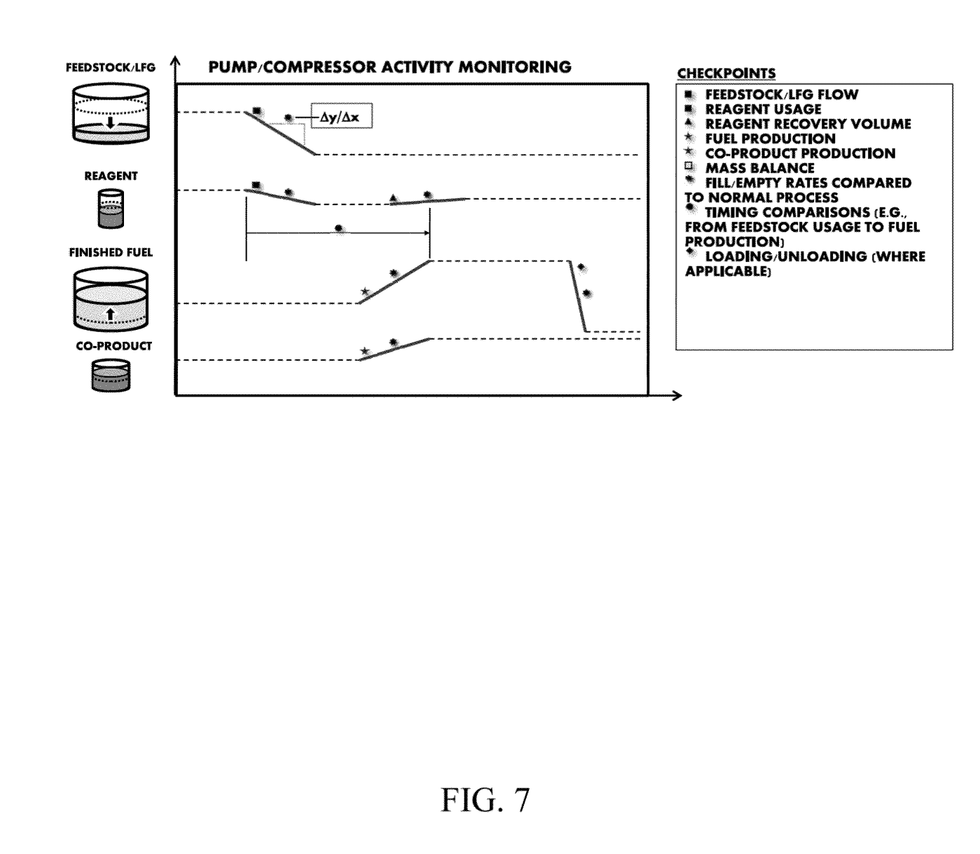

During normal operations of a production facility, the operational profile regarding mass balances associated with each stage in the production of the renewable fuel will follow a defined pattern. FIG. 7 is a schematic view illustrating a typical mass-balance profile for a biodiesel production facility. Monitoring this mass-balance profile over time can be used to derive information as to whether the production facility is operating normally or abnormally, and hence allow the detection of production anomalies or other operational inconsistencies. In other words, the mass-balance profile should reflect that all of the materials entering a process (or a functional subsection) equals all the materials being processed or currently exiting a process (or a functional section of the production facility):

Vᵢₙ=Vᵢₙ₁+Vᵢₙ₂+Vᵢₙ₃+ . . . +ΣVᵢₙᵢ (3)

V_{process}=V_{process1}+V_{process2}+V_{process3}+ . . . +ΣV_{processi} (4)

Vₒᵤₜ=Vₒᵤₜ₁+Vₒᵤₜ₂+Vₒᵤₜ₃+ . . . +ΣVₒᵤₜᵢ (5)

Vᵢₙ=V_{process}=Vₒᵤₜ (6)

where Vᵢₙ is the total volume derived from the flow rates of all incoming pumps, V_{process} is the total volume derived from the flow rates of all pumps moving product into process, and Vₒᵤₜ is the total volume derived from the flow rates of all outgoing pumps.

Abnormal operations at a production facility can then be defined as any time that equation (6) is not true.

In addition, and as illustrated in FIG. 7, the rate of change in materials moving into or out of a particular process (or a functional section of the production facility) should follow a consistent pattern. For instance, an expected pump usage profile dictates that the pumps associated with Vᵢₙ should come on first in any given cycle, followed by the pumps associated with V_{process}, followed by the pumps associated with Vₒᵤₜ. If pumps are not seen to follow the expected patterns of switching on or appear to follow expected rates of material transfer, then abnormal operations can be communicated to interested parties.

### EXAMPLE TRANSFORM 2

### Transforming Tank Level Signals Into a Production Flow Rate and Mass Balance

For a tank levelmeter installed on a tank, the meter outputs a net volume change, ΔVᵢ, which is calculated by subtracting the total amount of material injected into a tank, ΣVᵢᵢ, from the total amount of material withdrawn from a tank, ΣV_{wi}, or:

ΔVᵢ=ΣVᵢᵢ−ΣV_{wi} (7)

As discussed above, FIG. 2 is a chart illustrating a tank level signal for a storage tank a biodiesel production facility. When taken over time, the net volume change can also be viewed as a variation of equation (2) above as follows:

Qᵢ=ΔVᵢ/Δt (8)

where Qᵢ is the flow rate through the tank, and Δt is the change in time.

By accessing and using other available information from the production facility (whether from public databases, prior collected data, information acquired from the production facility, or otherwise), such as production data, flow meter data, or additional tank level data, a transform is then established to verify the net volume change, ΔVᵢ, and corresponding flow rate of material through in the tank, Qᵢ. If the measured net volume change and flow rate of material through the tank is not within an acceptable error of the net volume change and flow rate determined through the collection of production facility data, the net volume change and flow rate can then be defined as

Vᵢ=Vᵢₘ+Vᵢₑᵣᵣ (9)

Qᵢ=Qᵢₘ+Qᵢₑᵣᵣ (10)

where Vᵢₘ is the measured volume change in the tank, Qᵢₘ is the measured flow rate through the tank, Vᵢₑᵣᵣ is i a value to offset the error between the measured flow rate and production facility data, and Qᵢₑᵣᵣ is a value to offset the error between the flow rate measurement and production facility data.

Once one or more tanks of a production facility have been identified and sensors have been placed to collect data from such tanks, the overall flow of materials through the production facility can be monitored. Specifically, when the flow rate of material, Qᵢ, through each tank at a given time has been calculated, the volume of material flowing into and out of each functional subsection, Vᵢ, can be estimated using equation (9).

During normal operations of a production facility, the operational profile regarding mass balances associated with each stage in the production of the renewable fuel will follow a defined pattern. Again, FIG. 7 illustrates a typical mass-balance profile for a biodiesel production facility. Monitoring this mass-balance profile over time can be used to derive information as to whether the production facility is operating normally or abnormally, and hence allow the detection of production anomalies or other operational inconsistencies. Again, the mass-balance profile should reflect that all of the materials entering a process (or a functional section of the production facility) equal all the materials being processed or currently exiting a process (or a functional section of the production facility):

Vᵢₙ=Vᵢₙ₁+Vᵢₙ₂+Vᵢₙ₃+ . . . +ΣVᵢₙᵢ (11)

V_{process}=V_{process1}+V_{process2}+V_{process3}+ . . . +ΣV_{processi} (12)

Vₒᵤₜ=Vₒᵤₜ₁+Vₒᵤₜ₂Vₒᵤₜ₃+ . . . +ΣVₒᵤₜᵢ (13)

Vᵢₙ=V_{process}=Vₒᵤₜ (14)

where Vᵢₙ is the sum of volumes injected into all incoming tanks, V_{process} is the sum of the volumes injected into all tanks moving product into process, and Vₒᵤₜ is sum of the volume withdrawn from all outgoing tanks

Abnormal operations at a production facility can then be defined as any time that equation (14) is not true.

In addition, and as also illustrated in FIG. 7, the rate of change in materials moving into or out of a particular process (or a functional section of the production facility) should follow a consistent pattern. For instance, an expected tank injection and withdrawal profile dictates that tanks associated with Vᵢₙ should first show an injection and then a withdrawal of material first in any given cycle, followed by an injection in the pumps associated with V_{process}. Similarly, tanks associated with V_{process} should show an injection and then a withdrawal of material first in any given cycle, followed by an injection in the pumps associated with Vₒᵤₜ. Lastly, the tanks associated with Vₒᵤₜ should show an injection and eventually a withdrawal of material. If tank injections and withdrawals are not seen to follow the expected patterns or appear to follow expected rates of material transfer, then abnormal operations can be communicated to interested parties.

### EXAMPLE TRANSFORM 3

### Transforming Flowmeter Signals Into a Production Flow Rate and Mass Balance

For a flowmeter installed on a pipe associated with the movement of material from one functional subsection to another in a biodiesel production facility, the flowmeter outputs a flow signal, Qᵢ, and cumulative volume signal, Vᵢ. FIG. 3 is a chart illustrating both the flow signal, Qᵢ, and cumulative volume signal, Vᵢ, over a 24-hour time period from a flowmeter installed in a pipe that delivers finished biodiesel to a truck or other transport means. The flow signal and volume signal correspond to one another as shown in equation (2) above.

By accessing and using other available information from the production facility (whether from public databases, prior collected data, information acquired from the production facility, or otherwise), such as production data, additional flow meter data, or tank level data, a transform is then established to verify the net volume change, ΔVᵢ, and corresponding flow rate of material through in the pipe, Qᵢ. If the measured net volume change and flow rate of material through the pipe is not within an acceptable error of the net volume change and flow rate determined through the collection of production facility data, the net volume change and flow rate can then be defined as

Vᵢ=Vᵢₘ+Vᵢₑᵣᵣ (15)

Qᵢ=Qᵢₘ+Qᵢₑᵣᵣ (16)

where Vᵢₘ is the measured volume change in the pipe, Qᵢₘ is the measured flow rate through the pipe, Vᵢₑᵣᵣ is a value to offset the error between the measured flow rate and production facility data, and Qᵢₑᵣᵣ is a value to offset the error between the flow rate measurement and production facility data.

Once one or more pipes related to a production facility have been identified, and flowmeters have been placed to collect data from such pipes, the overall flow of materials through the production facility or a functional subsection of the production facility can be monitored. Specifically, when the flow rate of material, Qᵢ, through each pipe at a given time has been calculated, the volume of material flowing into and out of each functional subsection, Vᵢ, can be estimated using equation (2) above.

During normal operations of a production facility, the operational profile regarding mass balances associated with each stage in the production of the renewable fuel will follow a defined pattern. Again, FIG. 7 illustrates a typical mass-balance profile for a biodiesel production facility. Monitoring this mass-balance profile over time can be used to derive information as to whether the production facility is operating normally or abnormally, and hence allow the detection of production anomalies or other operational inconsistencies. Again, the mass-balance profile should reflect that all of the materials entering a process (or a functional section of the production facility) equal all the materials being processed or currently exiting a process (or a functional section of the production facility):

Vᵢₙ=Vᵢₙ₁+Vᵢₙ₂+Vᵢₙ₃+ . . . +ΣVᵢₙᵢ (17)

V_{process}=V_{process1}+V_{process2}+V_{process3}+ . . . +ΣV_{processi} (18)

Vₒᵤₜ=Vₒᵤₜ₁+Vₒᵤₜ₂+Vₒᵤₜ₃+ . . . +ΣVₒᵤₜᵢ (19)

Vᵢₙ=V_{process}=Vₒᵤₜ (20)

where Vᵢₙ is the sum of volumes through incoming pipes, V_{process} is the sum of the volumes through all pipes moving product into process, and Vₒᵤₜ is the sum of the volumes through all outgoing pipes.

Abnormal operations at a production facility can then be defined as any time that equation (20) is not true.

In addition, and as also illustrated in FIG. 7, the rate of change in materials moving into or out of a particular process (or a functional section of the production facility) should follow a consistent pattern. For instance, an expected usage profile dictates that the pipes associated with Vᵢₙ should have material flow through them first in any given cycle, followed by the pipes associated with V_{process,} followed by the pipes associated with V_{out.} If pipes are not seen to follow the expected flow patterns or appear to follow expected rates of material transfer, then abnormal operations can be communicated to interested parties.

### EXAMPLE TRANSFORM 4

### Transforming Pump Sensor Current Signals Into Normal/Abnormal Operational State Determination

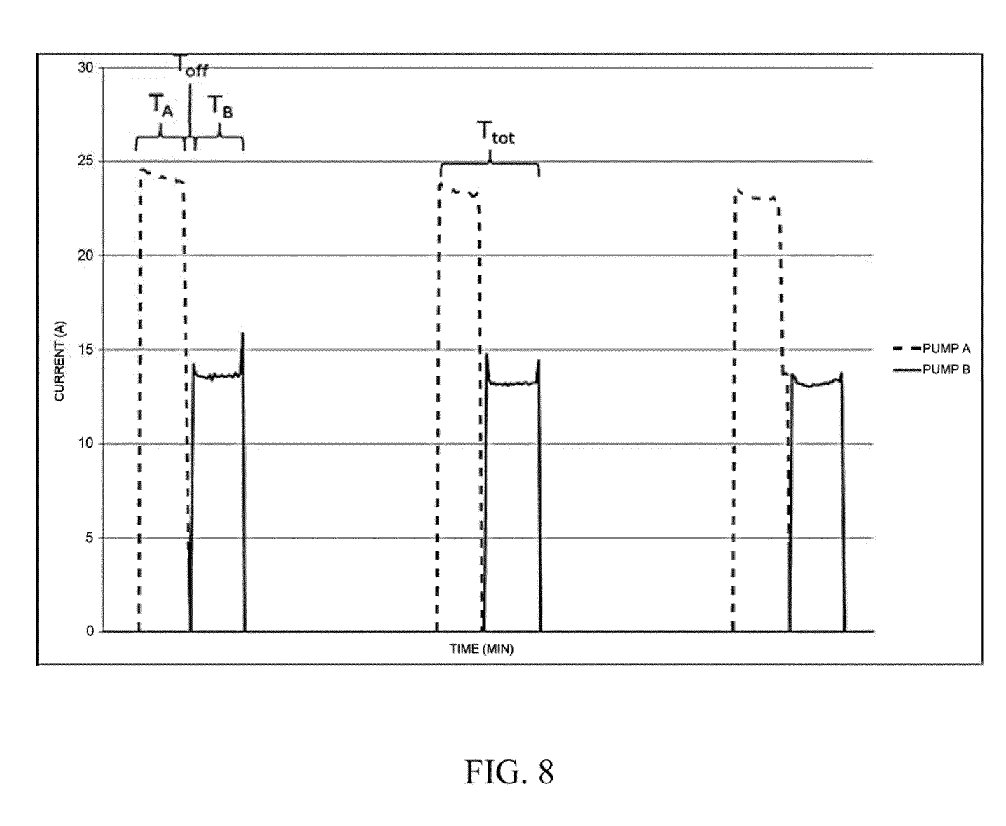

FIG. 8 is a chart that plots the measured current from the sensors for Pumps A and B of a biodiesel production facility. In normal operation, Pump A is associated with a transesterification processing tank, which typically would come on first in the processing area of a biodiesel production facility, while Pump B is associated with a separation processing tank, which would come on after Pump A. As shown in FIG. 8, one pumping sequence shows that Pump A runs for a total period of 20 minutes, i.e., T_{A =}20 minutes before switching off for one minute, i.e., delta T_{off=}1 minute. Pump B then runs for a total period of 20 minutes, i.e., T_{B=}20 minutes. This creates a total pumping period of 41 minutes, i.e., Tₜₒₜ₌41 minutes.

Tₜₒₜ=T_{A}+T_{off}+T_{B} (21)

By measuring the length of time between the last trailing edge of one pumping period and the start leading edge of the next pumping period, an expected pumping sequence can be identified. Such a pumping sequence identifies normal operations at a production facility, and any deviations would be considered abnormal operations.

In order to determine the pumping sequence relationship on a real-time basis, a cross-correlation function is applied to the current output signals. The function used to determine the relationship between the two signals is:

$$( A * B ) ( m ) = \{ \begin{matrix}{\sum }_{n = 0}^{N - m - 1} {A}_{n + m} {B}_{n}^{*} & m \geq 0 \\ ( A * B ) ( - m ) & m < 0\end{matrix} \qquad ( 22 )$$

where A and B represent the pump current signals, and N is the total number of signal data points used in the cross-correlation function for A and B.

A Matlab® script can be used to analyze this data on a real-time basis using the xcorr function. (Matlab® is a registered trademark of The Mathworks Inc. of Natick, Mass.)

The xcorr function returns a vector, c, of length 2N-1 containing the cross correlation sequence.

c=xcorr(A,B) (23)

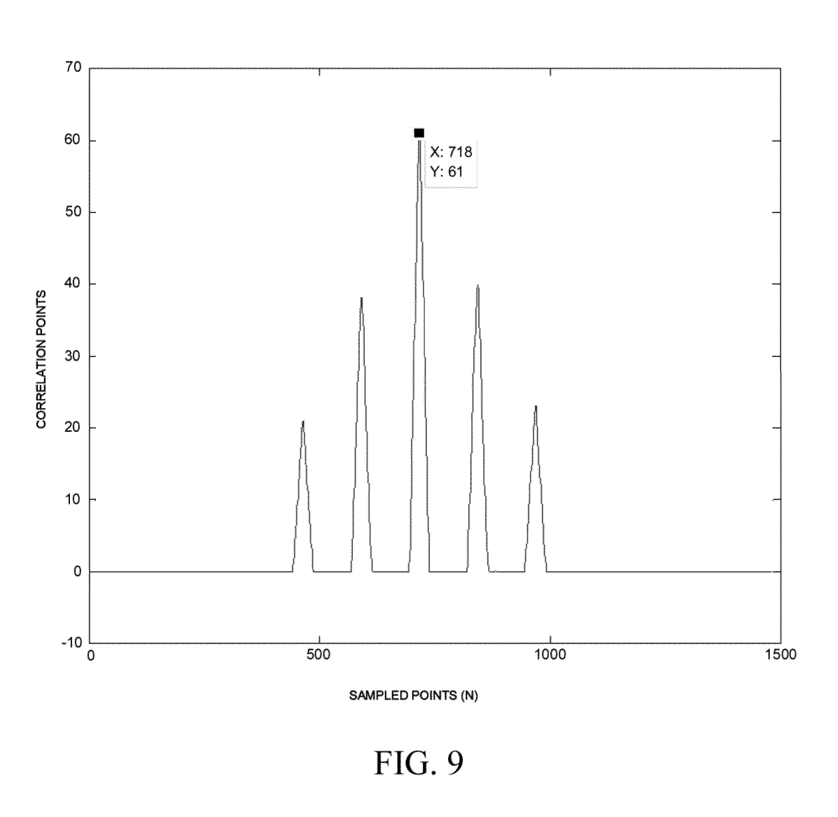

Using c, the time lag, T_{iag}, between pumping sequences can be determined by subtracting the position of the highest correlated point (zero lag) from N. FIG. 9 is a chart that illustrates the use of such a cross-correlation function, where the highest correlation occurs at x=718.

Now, in order to ascertain how well the two signals correspond to one another at the highest correlated point, the correlation coefficient vector, r, is found using the same Matlab® xcorr function as above with an additional option.

r=xcorr(A,B,‘coeff’) (24)

It can thus be determined that Pump A begins operations at an expected lag, T_{lag}, of 23 minutes before Pump B begins to operate. This is confirmed by a coefficient of correlation, R, of 0.94. Thus, every time Pump A begins operations, it is expected that Pump B will begin operations 23 minutes later. If it does not happen, or if it is determined that Pump B begins operations before Pump A, an abnormal operational pattern is identified. Data on normal or abnormal operation can then be communicated to interested parties.

### EXAMPLE TRANSFORM 5

### Transforming Tank Level Signals Into Normal/Abnormal Operational State Determination

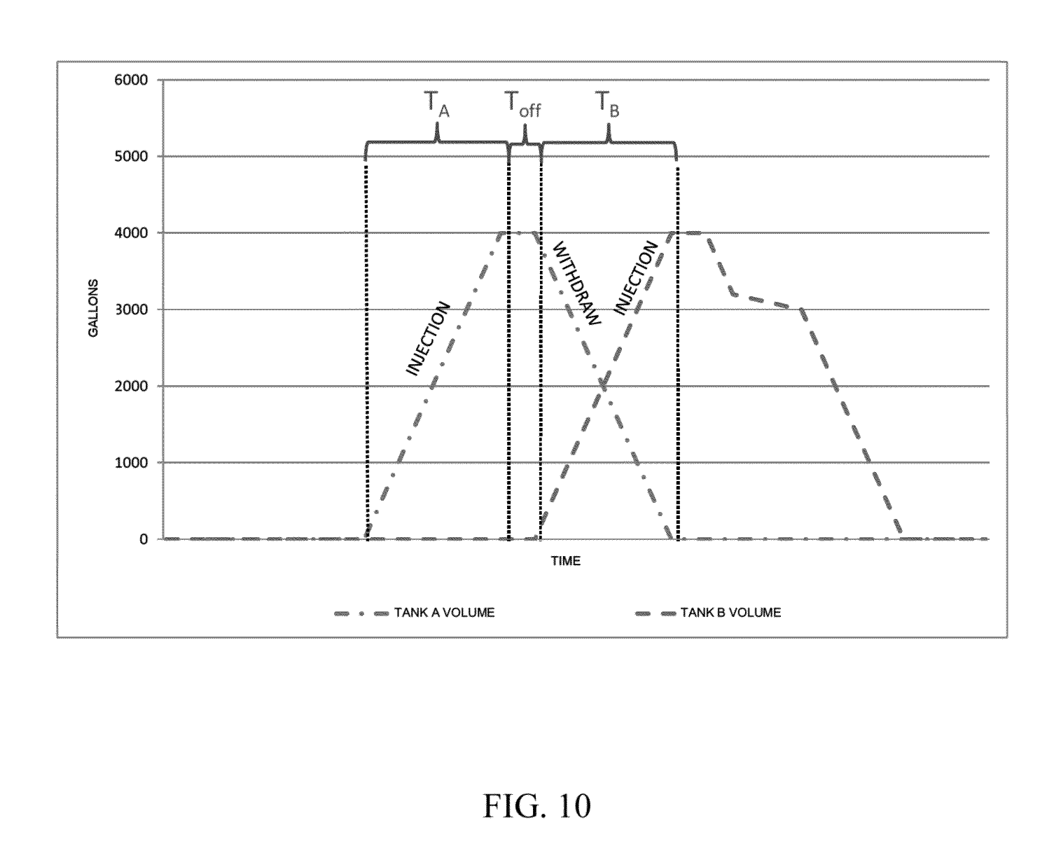

FIG. 10 is a chart that plots the measured volume change over time from tank level sensors for Tanks A and B of a biodiesel production facility. In normal operation, Tank A is a transesterification processing tank, which typically would receive processing materials first in the processing area of a biodiesel production facility, while Tank B is a separation processing tank, which would receive materials after Tank A. Specifically, the materials in Tank A would be directly transferred to Tank B. As shown in FIG. 10, one transfer sequence shows Tank A is injected with material with total period of 20 minutes, i.e., T_{A=}20 minutes then remains static while the material is processed within the tank, i.e., T_{off=}5 minutes. Tank A then begins to withdraw material, as Tank B is concurrently injected with the same material with a total period of 20 minutes, i.e., T_{B=}20 minutes before the level in Tank B becomes static. This creates a total transfer period of 45 minutes, i.e., Tₜₒₜ₌45 minutes.

ₜₒₜ=T_{A}+T_{off}+T_{B} (25)

By measuring the length of time between the last trailing edge of one injection period and the start leading edge of the next injection period, an expected transfer sequence can be identified. Such a transfer sequence identifies normal operations at a production facility, and any deviations would be considered abnormal operations.

In order to determine the transfer sequence relationship on a real-time basis, a cross-correlation function is applied to the volume change signals. The function used to determine the relationship between the two signals is:

$$( A * B ) ( m ) = \{ \begin{matrix}{\sum }_{n = 0}^{N - m - 1} {A}_{n + m} {B}_{n}^{*} & m \geq 0 \\ ( A * B ) ( - m ) & m < 0\end{matrix} \qquad ( 26 )$$

where A and B represent the volume change signals, and N is the total number of signal data points used in the cross-correlation function for A and B.

Again, a Matlab® script can be used to analyze this data on a real-time basis using the xcorr function. The xcorr function returns a vector, c, of length 2N-1 containing the cross correlation sequence.

c=xcorr(A,B) (27)

Using c, the time lag, T_{lag}, between transfer sequences can be determined by subtracting the position of the highest correlated point (zero lag) from N. Again, FIG. 9 is a chart that illustrates the use of such a cross-correlation function, where the highest correlation occurs at x=718.

Now, in order to ascertain how well the two signals correspond to one another at the highest correlated point, the correlation coefficient vector, r, is found using the same Matlab® xcorr function as above with an additional option.

r=xcorr(A,B,‘coeff’) (28)

It can thus be determined that Tank A begins injection at an expected lag, T_{lag}, of 23 minutes before Tank B begins to inject material. This is confirmed by a coefficient of correlation, R, of 0.94. Thus, every time Tank A begins injection, it is expected that Tank B will begin injection 23 minutes later. If it does not happen, or if it is determined that Tank B begins injection before Tank A, an abnormal operational pattern is identified. Again, data on normal or abnormal operation can then be communicated to interested parties.

### EXAMPLE TRANSFORM 6

### Transforming Flowmeter Signals Into Normal/Abnormal Operational State Determination

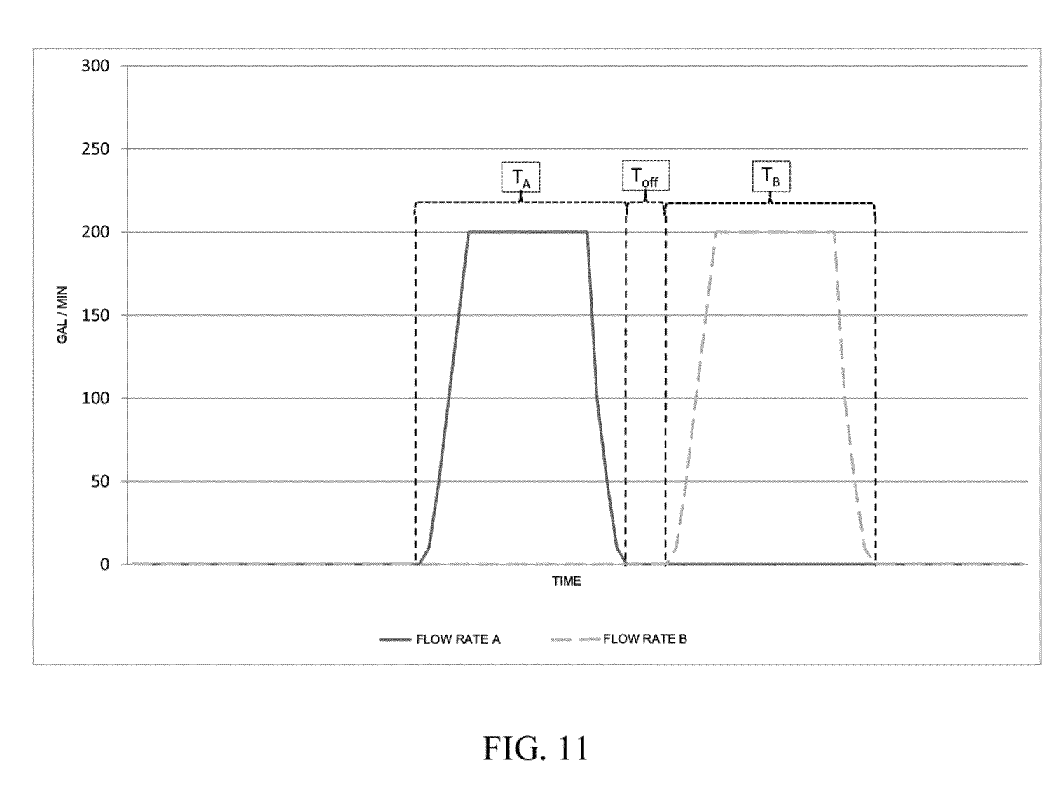

FIG. 11 is a chart that plots the measured flow rate through Pipes A and B of a biodiesel production facility using flowmeter sensors. In normal operation, Pipe A moves material from pre-processing into a transesterification processing tank, which would typically come on first in the processing area of a biodiesel production facility, while Pipe B moves material from the transesterification to the separation processing tank, which would transfer material after Pipe A. As shown in FIG. 11, one transfer sequence shows material moving through Pipe A for a total period of 20 minutes, i.e., T_{A=}20 minutes before switching off for 5 minutes, i.e., delta T_{off=}5 minutes. Material then flows through Pipe B for a total period of 20 minutes, i.e., T_{B=}20 minutes. This creates a total transfer period of 45 minutes, i.e., Tₜₒₜ₌45 minutes.

Tₜₒₜ=T_{A}+T_{off}+T_{B} (29)

By measuring the length of time between the last trailing edge of one pipe flow period and the start leading edge of the next pipe flow period, an expected transfer sequence can be identified. Such a transfer sequence identifies normal operations at a production facility, and any deviations would be considered abnormal operations.

In order to determine the transfer sequence relationship on a real-time basis, a cross-correlation function is applied to the flow rate signals. The function used to determine the relationship between the two signals is:

$$( A * B ) ( m ) = \{ \begin{matrix}{\sum }_{n = 0}^{N - m - 1} {A}_{n + m} {B}_{n}^{*} & m \geq 0 \\ ( A * B ) ( - m ) & m < 0\end{matrix} \qquad ( 30 )$$

where A and B represent the flow rate signals, and N is the total number of signal data points used in the cross-correlation function for A and B.

Again, a Matlab® script can be used to analyze this data on a real-time basis using the xcorr function. The xcorr function returns a vector, c, of length 2N-1 containing the cross correlation sequence.

c=xcorr(A,B) (31)

Using c, the time lag, T_{lag}, between transfer sequences can be determined by subtracting the position of the highest correlated point (zero lag) from N. Again, FIG. 9 is a chart that illustrates the use of such a cross-correlation function, where the highest correlation occurs at x=718.

Now, in order to ascertain how well the two signals correspond to one another at the highest correlated point, the correlation coefficient vector, r, is found using the same Matlab® xcorr function as above with an additional option.

r=xcorr(A,B,‘coeff’) (32)

It can thus be determined that material begins flow through Pipe A at an expected lag, T_{lag}, of 23 minutes before material begins to flow through Pipe B. This is confirmed by a coefficient of correlation, R, of 0.94. Thus, every time material begins flow through Pipe A, it is expected that material flow through Pipe B will begin 23 minutes later. If it does not happen, or if it is determined that material flows through Pipe B before Pipe A, an abnormal operational pattern is identified. Again, data on normal or abnormal operation can then be communicated to interested parties.

### EXAMPLE TRANSFORM 7

### Transforming Parameters Associated with a Pump Sensor Current Signal Into a Method to Identify Export Vehicle Type, Container Fill Rates, and/or Container Type

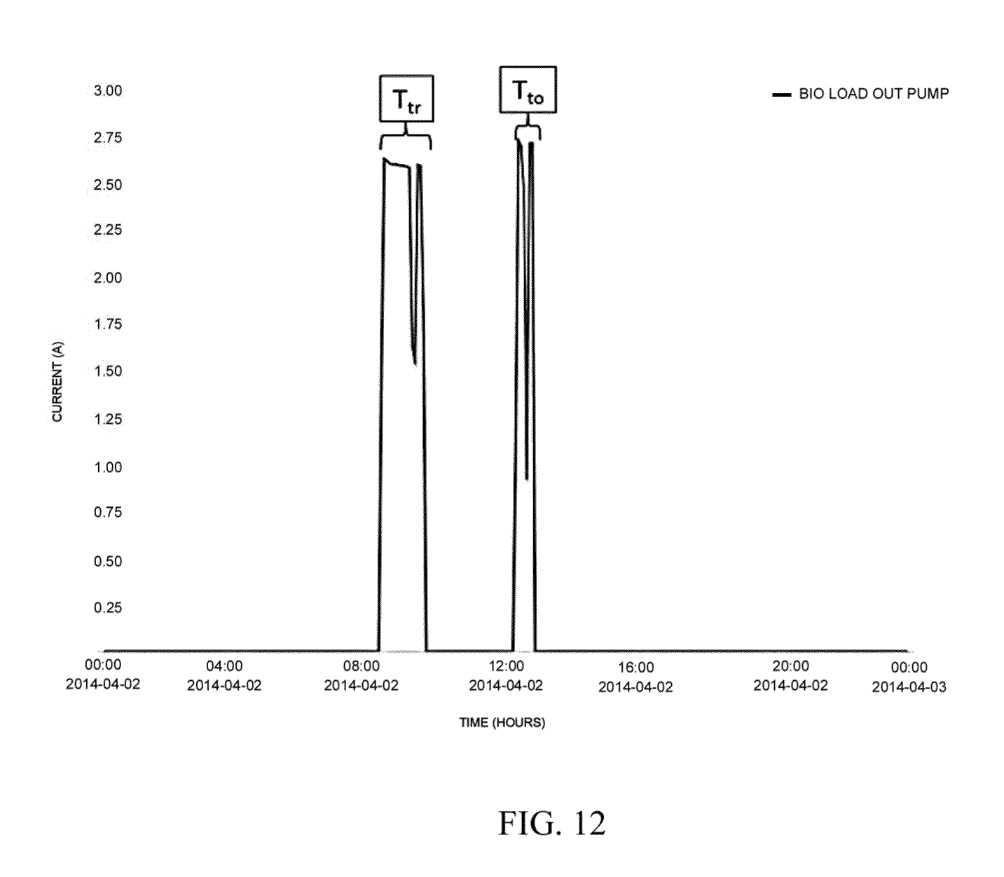

It can also be determined what a particular pump is being used for at a production facility based on certain signal characteristics, including period of pump usage, amplitudes, leading edge patterns, number of peaks, and ramp/decay rates. FIG. 12 is a chart of two signals from a single sensor associated with a load-out pump. By applying pattern recognition to the pump current signals, the load-out operation can be completely profiled.

As shown in FIG. 12, the period of the first signal (Tₜᵣ) was approximately 60 minutes, while the period of the second signal (Tₜₒ) was approximately 30 minutes. Also, the first signal has a longer period of uninterrupted flow (as there is no decay in the pump sensor current) as compared to the second signal, which indicates that more material was pumped during the first period. Based on shipment information acquired from other sources (such as imaging technologies, flow metering technologies, data provided by the production facilities, or patterns of pumping gathered in a database of historically observed signal patterns), it can be determined, for example, that the first signal, Sₜᵣ, was representative of product pumped into a tractor trailer, and the second signal, Sₜₒ, was representative of product being pumped into a smaller tote. With this known information, a pattern recognition algorithm can be used to define different pumping signals, Sᵢ, present at a production facility. For example, one technique would be to use the xcorr function in Matlab® and the coeff option to find the coefficient of correlation at zero lag, r₀:

r₀=xcorr(Sᵢ,Xᵢ,0,‘coeff’) (33)

where Sᵢ is the signal associated with a known pumping type, and Xᵢ is the signal associated with an unknown pumping type. r₀ will be a value between 0 and 1; the more correlation between the signals, the closer r₀ will be to 1. Based on r₀'s value set against expected r₀ results set for a particular pump, it can be determined if the unknown signal matches any known signals (S₁, S₂, S₃, etc.) or if it is a new type of signal.

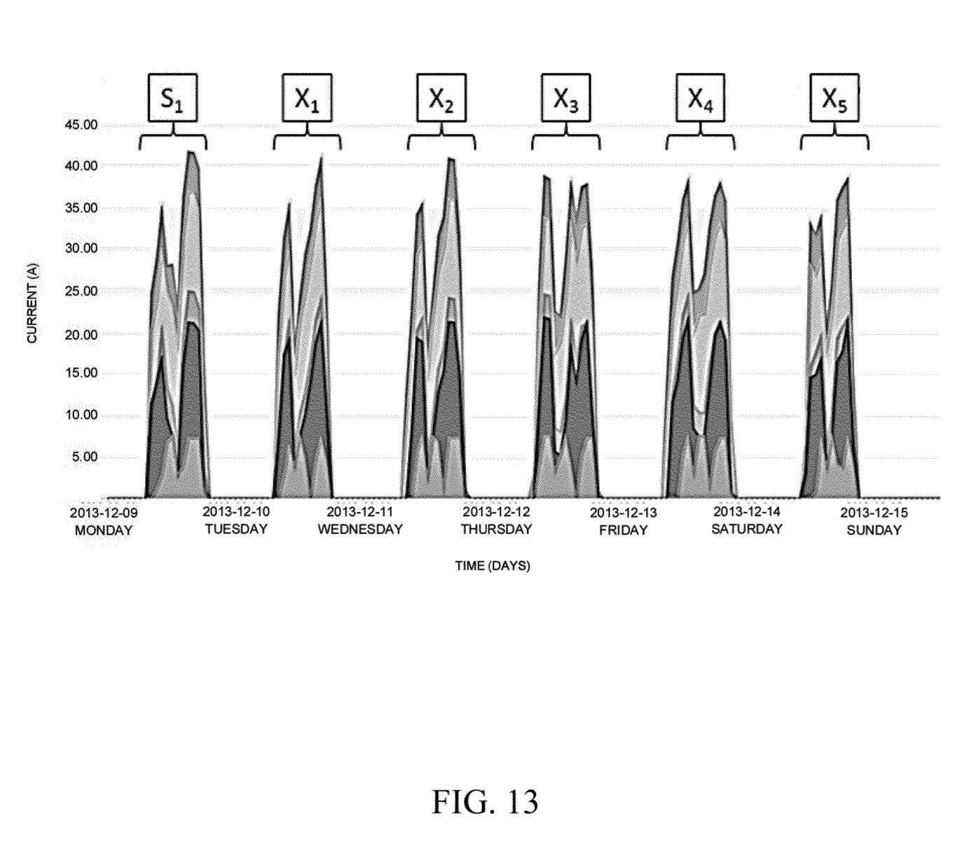

Similar analysis can be used to determine expected operational patterns at different time granularities as well. During normal operational periods, pump usage is expected to be similar from day-to-day, as reflected in FIG. 13, which is a chart of total pump usage over several daily periods. This same analysis can be performed using different time granularities, such as weekly or monthly time periods, or by using only a subset of pumps. In FIG. 13, S_{i,} is defined as the expected daily pump current usage (by current draw) for all pumps at a production facility, and Xᵢ is the signal associated with pump usage over each daily period. Using equation (33), the expected daily signal, S₁, can be compared to each daily sample, X_{i,} to determine abnormal operations. Based on r₀'s value set against expected r₀ results set for daily operations, it can be determined if Xᵢ matches any known daily signals (S₁, S₂, S₃, etc.) or if it is a new type of signal. If r₀ indicates that Xᵢ does not match any known daily signal, abnormal operations can be communicated to interested parties.

### EXAMPLE TRANSFORM 8

### Transforming Parameters Associated with a Tank Level Signal Into a Method to Identify Vehicle Type, Container Fill Rates, and/or Container Type

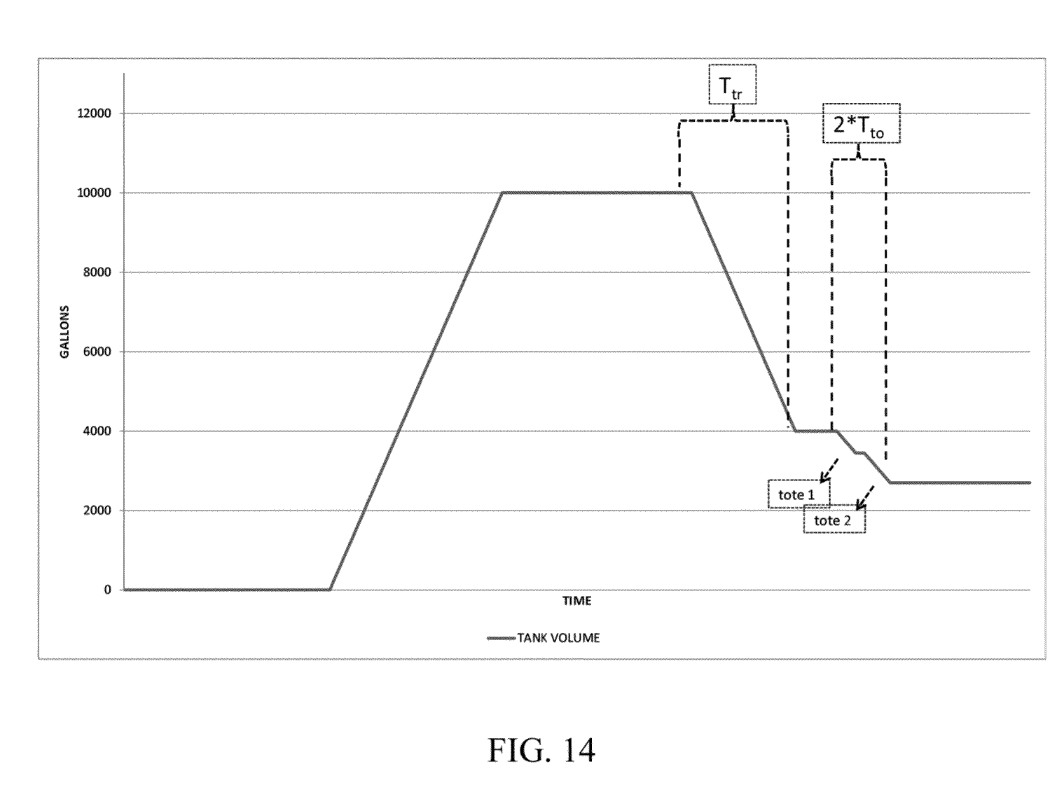

It can also be determined what a particular tank is being used for at a production facility based on certain signal characteristics, including period of tank injections/withdrawals, amplitudes (i.e., volumes injected or withdrawn from a tank), leading edge patterns, number of peaks, and ramp/decay rates. FIG. 14 is a chart of two signals from a single sensor associated with a final renewable fuel storage tank. By applying pattern recognition to the signals, the load-out operation can be completely profiled.

As shown in FIG. 14, the period of the first signal (Tₜᵣ) was approximately 60 minutes, while the period of the second signal (Tₜₒ) was approximately 30 minutes. Also, the first signal has a single period of uninterrupted flow as compared to the second signal, which indicates that flow was interrupted in the middle of the tank withdraw process. Based on shipment information acquired from other sources (such as imaging technologies, flow metering technologies, data provided by the production facilities, or patterns of pumping gathered in a database of historically observed signal patterns), it can be determined, for example, that the first signal, Sₜᵣ, was representative of product pumped into a tractor trailer, and the second signal, Sₜₒ, was representative of product being pumped into multiple smaller totes. With this known information, a pattern recognition algorithm can be used to define different tank level signals, Sᵢ, present at a production facility. For example, one technique would be to use the xcorr function in Matlab® and the coeff option to find the coefficient of correlation at zero lag, r₀:

r₀=xcorr(Sᵢ,X_{i,}0,‘coeff’) (34)

where Sᵢ is the signal associated with a known tank level change, and Xᵢ is the signal associated with an unknown tank level change. r₀ will be a value between 0 and 1; the more correlation between the signals, the closer r₀ will be to 1. Based on r₀'s value set against expected r₀ results set for a particular tank level change, it can be determined if the unknown signal matches any known signals (S₁, S₂, S₃, etc.) or if it is a new type of signal.

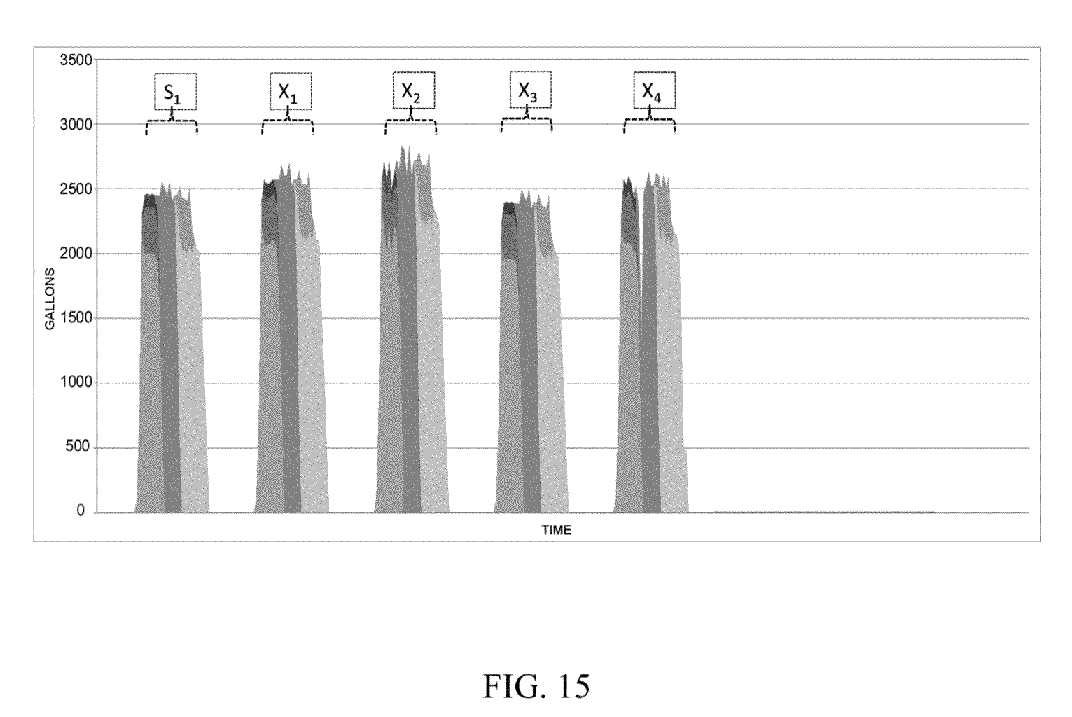

Similar analysis can be used to determine expected operational patterns at different time granularities as well. During normal operational periods, tank level changes are expected to be similar from day-to-day, as reflected in FIG. 15, which is a chart of total tank level injections and withdrawals over several daily periods. This same analysis can be performed using different time granularities, such as weekly or monthly time periods, or by using only a subset of tank storage information. In FIG. 15, Sᵢ is defined as the expected daily change of all tanks at a production facility, and Xᵢ is the signal associated with daily storage change over each daily period. Using equation (33), the expected daily signal, S₁, can be compared to each daily sample, Xᵢ, to determine abnormal operations. Based on r₀'s value set against expected r₀ results set for daily operations, it can be determined if Xᵢ, matches any known daily signals (S₁, S₂, S₃, etc.) or if it is a new type of signal. If r₀ indicates that Xᵢ does not match any known daily signal, abnormal operations can be communicated to interested parties.

### EXAMPLE TRANSFORM 9

### Transforming Parameters Associated with a Flowmeter Signal Into a Method to Identify Vehicle Type, Container Fill Rates, and/or Container Type

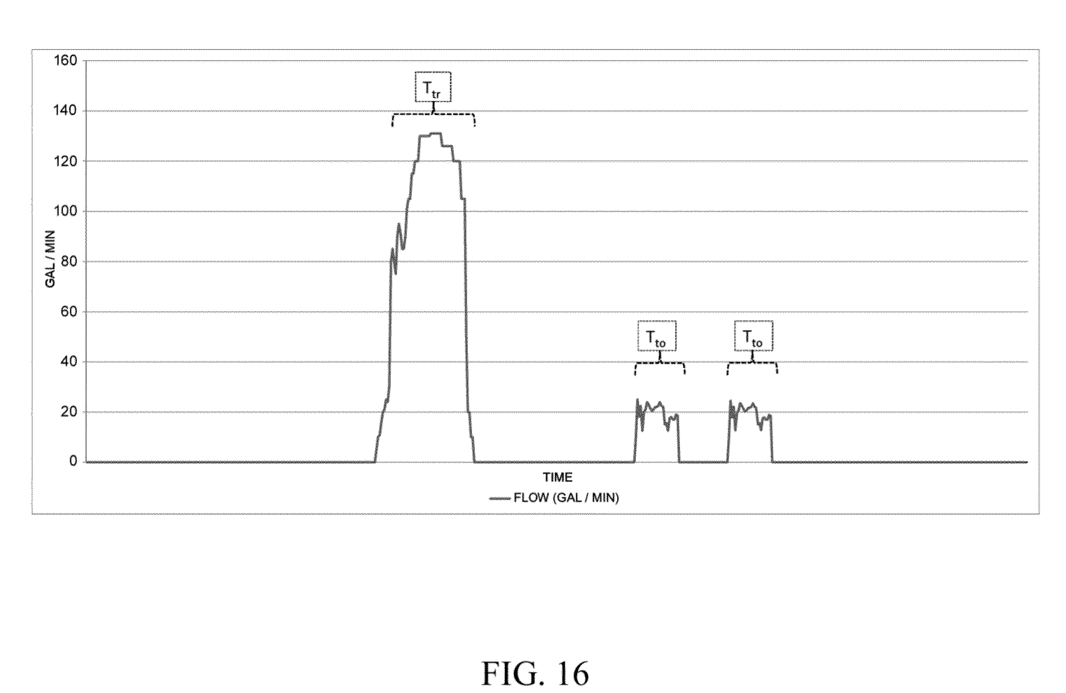

It can also be determined what a particular pipe is being used for at a production facility based on certain flow signal characteristics, including period of usage, amplitudes (i.e., flow rates), leading edge patterns, number of peaks, and ramp/decay rates. FIG. 16 is a chart of three signals from a single flowmeter associated with flow through a load-out pipe. By applying pattern recognition to the signals, the load-out operation can be completely profiled.

As shown in FIG. 16, the period of the first signal (Tₜᵣ) was approximately 60 minutes, while the period of the other signals (Tₜₒ) were approximately 30 minutes each. The flow rate of the first signal is higher than that of the other two, thus indicating a larger pump and/or larger pipe was used. Based on shipment information acquired from other sources (such as imaging technologies, flow metering technologies, data provided by the production facilities, or patterns of flow gathered in a database of historically observed signal patterns), it can be determined, for example, that the first signal, Sₜᵣ, was representative of product pumped through the monitored pipe into a tractor trailer and the second signal, Sₜₒ, was representative of product being pumped through the monitored pipe into a smaller tote. With this known information, a pattern recognition algorithm can be used to define different flow signals, Sᵢ, present at a production facility. For example, one technique would be to use the xcorr function in Matlab® and the coeff option to find the coefficient of correlation at zero lag, r₀:

r₀=xcorr(Sᵢ,X_{i,}0,‘coeff’) (35)

where Sᵢ is the signal associated with a known flow type, and Xᵢ is the signal associated with an unknown flow type. r₀ will be a value between 0 and 1; the more correlation between the signals, the closer r₀ will be to 1. Based on r₀'s value set against expected r₀ results set for flow through a particular pipe, it can be determined if the unknown signal matches any known signals (S₁, S₂, S₃, etc.) or if it is a new type of signal.

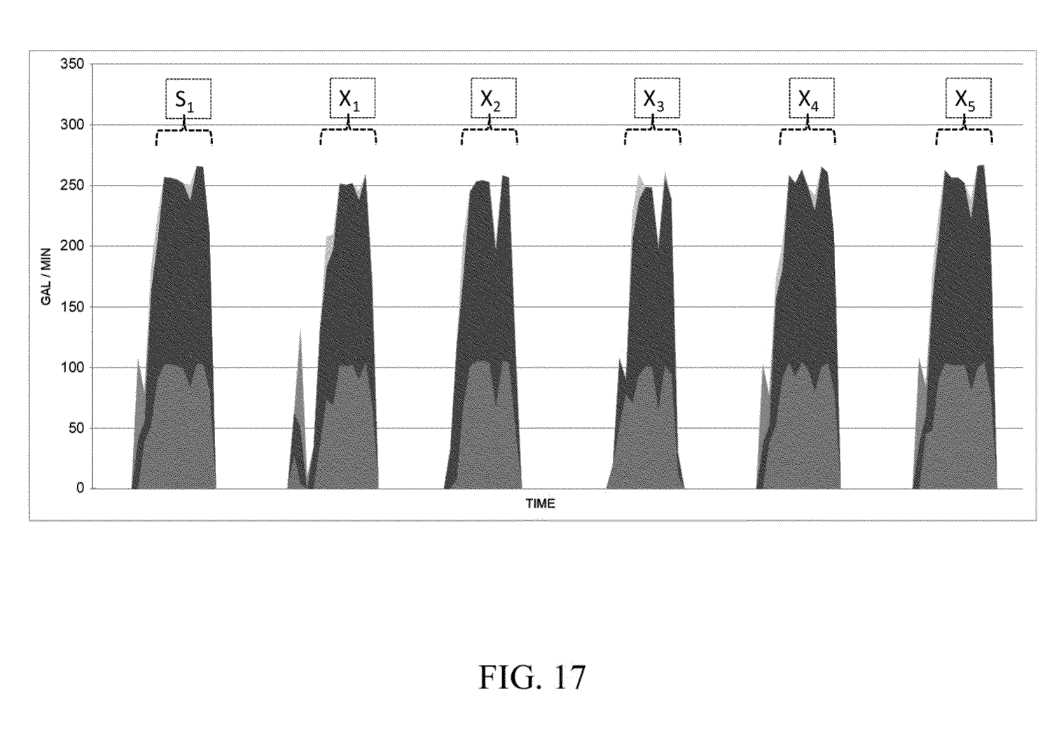

Similar analysis can be used to determine expected operational patterns at different time granularities as well. During normal operational periods, total flow through all pipes at a production facility is expected to be similar from day-to-day, as reflected in FIG. 17, which is a chart of total material flow at a production facility over several daily periods. In FIG. 17, Sᵢ is defined as the expected daily flow through all pipes at a production facility, and Xᵢ is the signal associated with flow over each daily period. This same analysis can be performed using different time granularities, such as weekly or monthly time periods, or by using only a subset of monitored pipes. Using equation (35), the expected daily signal, S₁, can be compared to each daily sample, Xᵢ, to determine abnormal operations. Based on r₀'s value set against expected r₀ results set for daily operations, it can be determined if Xᵢ matches any known daily signals (S₁, S₂, S₃, etc.) or if it is a new type of signal. If r₀ indicates that Xᵢ does not match any known daily signal, abnormal operations can be communicated to interested parties.

Again, and as described above in the Example Transforms, once established, as data is received from one or more sensors, as indicated by block 300 of FIG. 18, each transform can be applied to the data collected from the one or more sensors, as indicated by block 302 of FIG. 18. Such application of the transforms can be done in real-time or at scheduled intervals to analyze data over defined time periods. In any event, the result of each such application of a transform is a status of the production facility, whether expressed as a production rate or other quantity, or expressed as an operational status (for example, normal or abnormal operations). Again, that result is then communicated to interested parties, as indicated by output 304 of FIG. 18, for example, through electronic mail delivery and/or through export of the data to an access-controlled Internet web site, which interested parties can access through a common Internet browser program.

Furthermore, by monitoring operation of a production facility for a renewable fuel in this manner, it is possible to ensure that there is a true and accurate reporting of the number of gallons of renewable fuel produced and the number of registered RINs. Specifically, by monitoring certain operating conditions of the production facility and determining the status of the production facility or identifying any abnormal operations, it can be readily confirmed that the production facility did indeed produce the number of gallons of renewable fuel that have been reported and associated with registered RINs. In other words, a determination can be made as to whether the production rate (as determined through application of the transforms) over an defined time period is consistent with the registration of RINs for the same defined time period.

One of ordinary skill in the art will recognize that additional embodiments and implementations are also possible without departing from the teachings of the present invention. This detailed description, and particularly the specific details of the exemplary embodiments and implementations disclosed therein, is given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A method for monitoring a production facility for a renewable fuel, comprising the steps of:
identifying certain operating parameters for the production facility and storing those operating parameters in a database;
establishing a transform which models the production facility or a functional subsection thereof as a function of at least one operating condition, wherein the transform is based, in part, on the certain operating parameters, and storing the transform in a database;
monitoring the at least one operating condition of the production facility by collecting data from a sensor;
applying the transform to the data collected from the sensor to determine a status of the production facility; and
communicating the status of the production facility to an interested third party.

2. The method as recited in claim 1, wherein the status of the production facility is a production rate.

3. The method as recited in claim 2, and further comprising the step of determining whether the production rate over an defined time period is consistent with the registration of Renewable Identification Numbers (RINs) for the defined time period.

4. The method as recited in claim 1, wherein the sensor is selected from the group consisting of: current sensors, flowmeters, and level sensors.

5. A method for monitoring a production facility for a renewable fuel, comprising the steps of:
identifying certain operating parameters for the production facility and storing those operating parameters in a memory component of a computer system;
using a processor of the computer system to establish a transform which models the production facility or a functional subsection thereof as a function of at least one operating condition, wherein the transform is based, in part, on the certain operating parameters, and storing the transform in the memory component of the computer system;
using one or more sensors to monitor the at least one operating condition of the production facility;
using the processor of the computer system to collect data from the one or more sensors;
using the processor of the computer system to apply the transform to the data collected from the one or more sensors to determine a status of the production facility; and
using the processor of the computer system to communicate the status of the production facility to an interested party.

6. The method as recited in claim 5, wherein the status of the production facility is a production rate.

7. The method as recited in claim 5, and further comprising the step of using the processor of the computer system to determine whether the production rate over an defined time period is consistent with the registration of Renewable Identification Numbers (RINs) for the defined time period.

8. The method as recited in claim 5, wherein the one or more sensors are selected from the group consisting of: current sensors, flowmeters, and level sensors.

9. A method for monitoring a production facility for a renewable fuel, comprising the steps of:
identifying certain operating parameters for the production facility and storing those operating parameters in a database;
establishing a transform which models the production facility or a functional subsection thereof as a function of operation of one or more selected pumps of the production facility, wherein the transform is based, in part, on the certain operating parameters, and storing the transform in a database;
placing one or more sensors to monitor operation of the one or more selected pumps of the production facility;
using the one or more sensors associated with the one or more selected pumps to collect data regarding operation of each of the one or more selected pumps;
applying the transform to the data collected from the one or more sensors to determine a status of the production facility; and
communicating the status of the production facility to an interested party.

10. The method as recited in claim 9, wherein the one or more sensors measure current draw through power cables associated with the one or more selected pumps of the production facility.

11. The method as recited in claim 9, wherein the status of the production facility is a production rate.

12. The method as recited in claim 11, and further comprising the step of determining whether the production rate over an defined time period is consistent with the registration of Renewable Identification Numbers (RINs) for the defined time period.

13. The method as recited in claim 9, wherein the transform models total production of the production facility as a function of a measured current draw of the one or more selected pumps of the production facility.

14. A method for monitoring a production facility for a renewable fuel, comprising the steps of:
identifying certain operating parameters for the production facility and storing those operating parameters in a database;
establishing an expected pump usage profile for the production facility or a functional subsection thereof that is based, in part, on the certain operating parameters, and storing the expected pump usage profile in a database;
placing one or more sensors to monitor operation of the one or more selected pumps of the production facility;
using the one or more sensors associated with the one or more selected pumps to collect pump usage data;
generating an actual pump usage profile for the production facility or a functional subsection thereof based on the pump usage data;
comparing the actual pump usage profile to the expected pump usage profile to determine if there are any abnormal operations; and
communicating any determination of abnormal operations to an interested party.

15. The method as recited in claim 14, wherein the one or more sensors measure current draw through power cables associated with the one or more selected pumps of the production facility.

16. A method for monitoring a production facility for a renewable fuel, comprising the steps of:
identifying certain operating parameters for the production facility and storing those operating parameters in a database;
establishing a transform which models the production facility or a functional subsection thereof as a function of storage levels of one or more selected tanks of the production facility, wherein the transform is based, in part, on the certain operating parameters, and storing the transform in a database;
installing one or more level sensors on the one or more selected tanks of the production facility;
using the one or more level sensors associated with the one or more selected tanks to collect data regarding storage levels of each of the one or more selected tanks;
applying the transform to the data collected from the one or more level sensors to determine a status of the production facility; and
communicating the status of the production facility to an interested party.

17. The method as recited in claim 16, wherein the status of the production facility is a production rate.

18. The method as recited in claim 17, and further comprising the step of determining whether the production rate over an defined time period is consistent with the registration of Renewable Identification Numbers (RINs) for the defined time period.

19. A method for monitoring a production facility for a renewable fuel, comprising the steps of:
identifying certain operating parameters for the production facility and storing those operating parameters in a database;
establishing an expected tank injection and withdrawal profile for the production facility or a functional subsection thereof that is based, in part, on the certain operating parameters, and storing the expected tank injection and withdrawal profile in a database;
installing one or more level sensors on one or more selected tanks of the production facility;
using the one or more level sensors associated with the one or more selected tanks to collect tank storage data;
generating an actual tank injection and withdrawal profile for the production facility or a functional subsection thereof based on the tank storage data; and
comparing the actual tank injection and withdrawal profile to the expected tank injection and withdrawal profile to determine if there are any abnormal operations; and
communicating any determination of abnormal operations to an interested party.

20. A method for monitoring a production facility for a renewable fuel, comprising the steps of:
identifying certain operating parameters for the production facility and storing those operating parameters in a database;
establishing a transform which models the production facility or a functional subsection thereof as a function of flow rates through one or more selected pipes of the production facility, wherein the transform is based, in part, on the certain operating parameters, and storing the transform in a database;
installing one or more flowmeters on the one or more selected pipes of the production facility;
using the one or more flowmeters associated with the one or more selected pipes to collect data regarding flow rates through each of the one or more selected pipes;
applying the transform to the data collected from the one or more flowmeters to determine a status of the production facility; and
communicating the status of the production facility to an interested party.

21. The method as recited in claim 20, wherein the status of the production facility is a production rate.

22. The method as recited in claim 21, and further comprising the step of determining whether the production rate over an defined time period is consistent with the registration of Renewable Identification Numbers (RINs) for the defined time period.

23. A method for monitoring a production facility for a renewable fuel, comprising the steps of:
identifying certain operating parameters for the production facility and storing those operating parameters in a database;
establishing an expected transfer sequence for the production facility or a functional subsection thereof that is based, in part, on the certain operating parameters, and storing the expected transfer sequence in a database;
installing one or more flowmeters on one or more selected pipes of the production facility;
using the one or more flowmeters associated with the one or more selected pipes to collect flow data;
generating an actual transfer sequence for the production facility or a functional subsection thereof based on the flow data; and
comparing the actual transfer sequence to the expected transfer sequence to determine if there are any abnormal operations; and
communicating any determination of abnormal operations to an interested party.
